(19) United States
(12) Patent Application Publication
(10) Pub. No.: US 2002/0111399 A1
(43) Pub. Date: Aug. 15, 2002

(54) Water soluble air controlling agents for cementitious compositions

(76) Inventors: Jeffrey R. Bury, Macedonia, OH (US); Thomas M. Vickers JR., Concord Township, OH (US); John J. Luciano, Russell, OH (US); Samy Shendy, Cuyahoga Falls, OH (US)

Correspondence Address: JOSEPH G CURATOLO, ESQ., RENNER KENNER GREIVE BOBAK TAYLOR & WEBER, 24500 CENTER RIDGE ROAD, SUITE 280, WESTLAKE, OH, 44145, US

(21) Appl. No.: 09/732,529

(22) Filed: Dec. 7, 2000

Related U.S. Application Data
(60) Provisional application No. 60/170,056, filed on Dec. 10, 1999.

(51) Int. Cl. C08K 3/00

(52) U.S. Cl. 524/2

(57) ABSTRACT

Water soluble air controlling agents can be admixed with dispersant for cementitious compositions to provide an admixture for cementitious compositions that is stable over time. The water soluble air controlling agents are compatible with water based polycarboxylate polymer dispersants. Suitable water soluble air controlling agents include alkoxylated polymers. A cementitious composition is provided that includes cement, water, a dispersant for cementitious compositions, and a water soluble air controlling agent. A method is provided for making a cementitious composition that includes mixing cement, water, a dispersant for cementitious compositions, and a water soluble air controlling agent.

### CROSS REFERENCE TO RELATED APPLICATIONS

The present application claims priority from U.S. Provisional Patent Application 60/170,056, filed Dec. 10, 1999.

### FIELD OF THE INVENTION

The present invention is directed to air controlling agents that are used in conjunction with a dispersant for cementitious compositions to control air content in cementitious compositions. Particularly, the present invention is directed to water soluble air controlling agents used in conjunction with a dispersant for cementitious compositions.

### BACKGROUND OF THE INVENTION

Hydraulic cements, such as Portland cement, are used to form structural formations. Hydraulic cements can be mixed with aggregate to form mortars, which additionally include small aggregate and water, or concrete, which are mortars which additionally include large aggregate.

When working with hydraulic cements, it is desired to increase the slump and flow properties of the initially formed hydraulic cement composition to aid in placement of the composition and to extend the period of flowability in order to provide working time to finish the placement of the structure. Admixtures can be added to hydraulic cement that increase the slump and workability. Additionally, admixtures can be added that also reduce the amount of water required and to produce flowable cementitious compositions. The reduced water content increases the strength of the resulting hydraulic cement formation.

One admixture for increasing the flowability and reducing the water content is a polycarboxylate dispersant. Polycarboxylate dispersants are polymers with a carbon backbone with pendant side chains, wherein at least a portion of the side chains are attached to the backbone through a carboxyl group or an ether group. Polycarboxylate dispersants are very effective at dispersing and reducing the water content in hydraulic cements.

One drawback to polycarboxylate dispersants is that they have a tendency to entrain air in the cementitious composition during mixing. While some entrained air may be desired for particular applications, such as providing freeze-thaw durability to the cementitious composition, an excess of entrained air is detrimental to the compressive strength of the resulting hydraulic formation. Also, some insoluble defoamers, or contamination, can cause unpredictable air contents over time.

Generally in the construction industry, non-air entrained cementitious compositions having an air content of less than 3% is desired, with an air content of less than 2% being preferred. Air entraining admixtures are sometimes used to provide purposeful air contents of 5-8% which improves the freeze thaw durability of the cementitious mixture. When this is the case, it is desirable to be able to adjust the air content by changing the air entrainer dosage and to have the resulting air remain stable over time.

To overcome the excess entraining of air in cementitious compositions, defoamers have been added to the cementitious mix to reduce the air content to a desired level. Defoamers typically have been included with the polycarboxylate admixture. However, the defoamers used in the prior art have been non-water-soluble compositions. The problem with non-water-soluble defoamers is that they give an inadequate long term storage stability to the admixture. The polycarboxylate dispersant is generally a water soluble dispersant. When a non-water-soluble defoamer is used in conjunction with a water soluble dispersant, the mixture separates over time. This requires that the mixture be mixed prior to use.

Commercial defoamers typically contain a mixture of materials. The major part is an oil or organic liquid (up to 95 parts by weight), small particulate (up to 15 parts by weight), and a surfactant (up to 5 parts by weight).

Another technique used in the prior art has been the grafting of the defoamer onto the dispersant molecule.

What is needed in the industry is an air controlling agent that can produce controllable air contents in non-air entrained and air entrained cementitious compositions in the presence of a dispersant for cementitious compositions.

It is therefore an object of the invention to provide a water soluble air controlling agent in the presence of a dispersant for cementitious compositions that produces controllable air contents in non-air entrained and air entrained cementitious compositions.

It is another object of the invention to provide an admixture containing a water soluble air controlling agent and a dispersant for cementitious compositions that is stable over time.

### SUMMARY OF THE INVENTION

Water soluble air controlling agents can be mixed with a dispersant for cementitious compositions to provide an admixture for cementitious compositions that is stable over time. The water soluble air controlling agents are compatible with water based dispersants for cementitious compositions. The resulting compatible admixture has long term storage stability so that the admixture does not need to be mixed prior to use at the work site. The water soluble air controlling agent in the presence of a dispersant for cementitious compositions provides controllable air contents in non-air entrained and air entrained cementitious compositions.

The present invention provides an admixture for cementitious compositions comprising a water soluble air controlling agent and a dispersant for cementitious compositions.

The present invention also provides a cementitious composition comprising cement, water, a water soluble air controlling agent, and a dispersant for cementitious compositions.

The present invention also provides a method of making a cementitious composition comprising mixing cement, water, a water soluble air controlling agent, and a dispersant for cementitious compositions.

### DETAILED DESCRIPTION OF THE INVENTION

The term air controlling agent (ACA) refers to any material that functions to regulate the air content in cementitious compositions in a predictable manner.

The term dispersant for cementitious compositions throughout this specification includes polycarboxylate dispersants and oligomeric dispersants.

The term polycarboxylate dispersant throughout this specification refers to polymers with a carbon backbone with pendant side chains, wherein at least a portion of the side chains are attached to the backbone through a carboxyl group or an ether group. The term dispersant is also meant to include those chemicals which also function as a plasticizer, water reducer, fluidizer, antiflocculating agent, or superplasticizer for cementitious compositions. Examples of polycarboxylate dispersants can be found in U.S. Ser. No. 09/369,562 filed on Aug. 6, 1999, U.S. Ser. No. 09/371,627 filed on Aug. 11, 1999, U.S. Ser. No. 09/212,652 filed on Dec. 16, 1998, European Patent Application Publication EP753488, U.S. Pat. Nos. 5,158,996, 6,008,275, 6,136,950, U.S. Ser. No. 09/592,231 filed on Jun. 9, 2000, U.S. Pat. No. 5,609,681, 5,494,516; 5,674,929, 5,660,626, 5,668,195, 5,661,206, 5,358,566, 5,162,402, 5,798,425, 5,612,396, 6,063,184, and 5,912,284, 5,840,114, 5,753,744, 5,728,207, 5,725,657, 5,703,174, 5,665,158, 5,643,978, 5,633,298, 5,583,183, 5,393,343, which are incorporated herein by reference.

The term oligomeric dispersant throughout this specification refers to oligomers that are a reaction product of a component A, optionally component B, and component C that are defined in U.S. Pat. No. 6,133,347, U.S. Ser. No. 09/630,021 filed on Jul. 31, 2000, and U.S. Ser. No. 09/629,724 filed on Jul. 31, 2000, which are hereby incorporated by reference.

The dispersants used in combination with the air controlling agents are at least one of:

a) a dispersant of Formula (I)

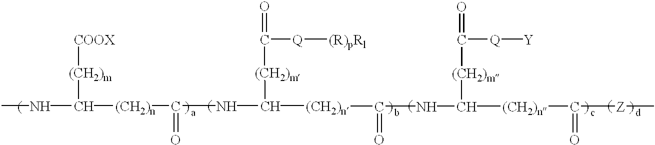

wherein in Formula (I)

X is at least one of hydrogen, an alkali earth metal ion, an alkaline earth metal ion, ammonium ion, and amine;

R is at least one of C₁ to C₆ alkyl(ene) ether and mixtures thereof and C₁ to C₆ alkyl(ene) imine and mixtures thereof;

Q is at least one of oxygen, NH, and sulfur;

p is a number from 1 to about 300 resulting in at least one of a linear side chain and branched side chain;

R₁ is at least one of hydrogen, C₁ to C₂₀ hydrocarbon, and functionalized hydrocarbon containing at least one of —OH, —COOH, an ester or amide derivative of —COOH, sulfonic acid, an ester or amide derivative of sulfonic acid, amine, and epoxy;

Y is at least one of hydrogen, an alkali earth metal ion, an alkaline earth metal ion, ammonium ion, amine, a hydrophobic hydrocarbon and polyalkylene oxide moiety that functions as a defoamer;

m, m′, m″, n, n′, and n″ are each independently 0 or an integer between 1 and about 20;

Z is a moiety containing at least one of i) at least one amine and one acid group, ii) two functional groups capable of incorporating into the backbone selected from the group consisting of dianhydrides, dialdehydes, and di-acid-chlorides, and iii) an imide residue; and

wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero.

b) a dispersant of Formula (II)

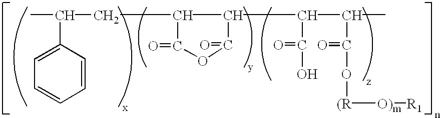

wherein in Formula (II):

R is a C₂₋₆ alkylene radical;

R₁ is a C₁₋₂₀ alkyl, C₆₋₉ cycloalkyl or phenyl group;

x, y, and z are number from 0.01 to 100;

m is a number from 1 to 100; and

n is a number from 10 to 100;

preferably, the ratio of x to (y+z) is from 1:10 to 10:1 inclusive, the ratio of

z:y is from 3:1 to 100:1, and m+n=15-100;

c) a dispersant of Formula (III)

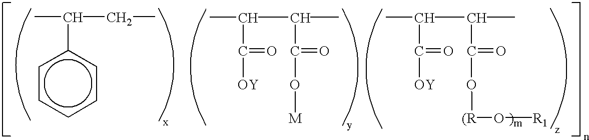

wherein in Formula (III):

M is hydrogen or the residue of a hydrophobic polyalkylene glycol or polysiloxane;

Y is hydrogen, an alkali or alkaline earth metal ion, ferrous ion,

aluminum ion, (alkanol)ammonium ion, or (alkyl)ammonium ion;

R is a C₂₋₆ alkylene radical;

R₁ is a C₁₋₂₀ alkyl, C₆₋₉ cycloalkyl, or phenyl group;

x, y, and z are numbers from 1 to 100;

preferably, the ratio of a to (b+c) is from 1:10 to 10:1 inclusive, the ratio of c:b is from 5:1 to 100:1, and m+n=15-100;

d) a dispersant comprising at least one polymer or a salt thereof having the form of a copolymer of

i) a maleic anhydride half-ester with a compound of the formula RO(AO)ₘH, wherein R is a C₁-C₂₀ alkyl group, A is a C₂₋₄ alkylene group, and m is an integer from 2-16; and

ii) a monomer having the formula CH₂═CHCH₂—(OA)ₙOR, wherein n is an integer from 1-90 and R is a C₁₋₂₀ alkyl group;

e) a reaction product formed by reacting a polycarboxylic acid with a nitrogeneous acrylic polymer;

f) a dispersant obtained by copolymerizing 5 to 98% be weight of an (alkoxy)polyalkylene glycol mono(meth)acrylic ester type monomer (a) represented by the following general formula (1):

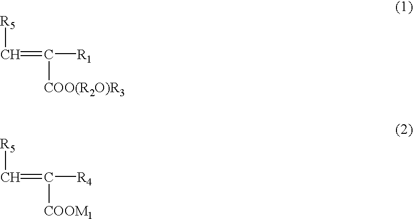

wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid type monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;

g) a graft polymer that is a polycarboxylic acid or a salt thereof, having side chains derived from at least one species selected from the group consisting of oligoalkyleneglycols, polyalcohols, polyalkylene glycols, and derivatives thereof;

h) a styrene-maleic anhydride copolymer in free acid or salt form, wherein the copolymer consists of the following types and numbers of monomer units:

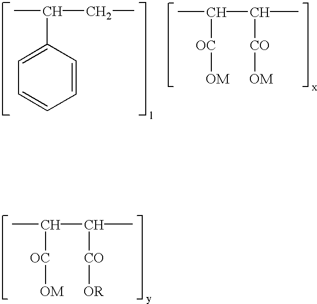

wherein:

M is selected from hydrogen, a cation and a residue of a hydrophobic polyalkylene glycol or polysiloxane;

R is the residue of a methylpoly(ethylene) glycol of weight average molecular weight 900-2000;

x=0.35-0.75; and

y=0.25-0.65;

i) a reaction product of component A, optionally component B, and component C; wherein each component A is independently a nonpolymeric, functional moiety that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof; wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof;

j) a dispersant of Formula (IV):

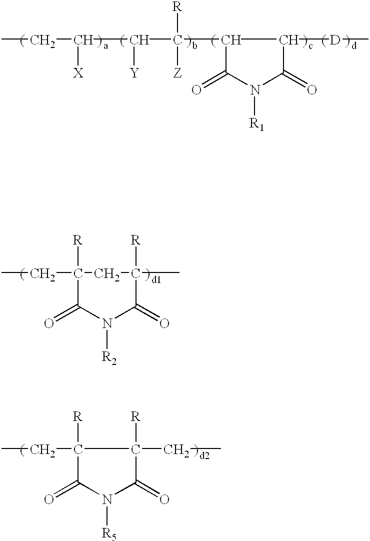

wherein in Formula (IV):

D=a component selected from the group consisting of the structure d1, the structure d2, and mixtures thereof;

X=H, CH₃, C₂ to C₆ Alkyl, Phenyl, Substituted Phenyl such as p-Methyl Phenyl, Sulfonated Phenyl;

Y=H,—COOM;

R=H, CH_{3;}

Z H, —SO₃M, —PO₃M, —COOM, —OR_{3,}—COOR₃, —CH₂OR_{3,}—CONHR₃, —CONHC(CH₃)₂ CH₂SO₃M, —COO(CHR₄)ₙOH where n=2 to 6;

R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;

R₄=H, Methyl, C₂ to about C₆ Alkyl, about C₆ to about C₁₀ aryl;

M=H, Alkali Metal, Alkaline Earth Metal, Ammonium, Amine, Substituted Amine such as triethanol amine, Methyl, C₂ to about C₆ Alkyl;

a=0 to about 0.8, preferably 0 to about 0.6, and most preferably 0 to about 0.5;

b=about 0.2 to about 1.0, preferably about 0.3 to about 1.0, and most preferably about 0.4 to about 1.0;

c=0 to about 0.5, preferably 0 to about 0.3, and most preferably 0 to about 0.1;

d=0 to about 0.5, preferably 0 to about 0.3, and most preferably 0 to about 0.1; and

wherein a, b, c, and d represent the mole fraction of each unit and the sum of a, b, c, anddis 1.0;

k) a dispersant of Formula (V):

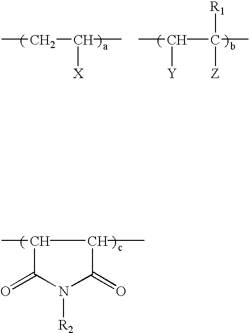

wherein in Formula (V):

the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;

X=H, CH₃, C₂ to C₆ Alkyl, Phenyl, or Substituted Phenyl such as p-Methyl Phenyl, p-Ethyl Phenyl, Carboxylated Phenyl, Sulfonated Phenyl and the like;

Y=H, —COOM, —COOH, or W;

W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the derivatized polycarboxylate dispersant;

Z=H, —COOM, —OR_{3,}—COOR_{3,}—CH₂OR₃, or —CONHR₃;

R₁=H, or CH₃;

R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;

R₄=H, Methyl, or C₂ to C₈ Alkyl;

R₅=C₁ to C₁₈ alkyl or C₆ to C₁₈ alkyl aryl;

M=Alkali Metal, Alkaline Earth Metal, Ammonia, Amine, Substituted Amine such as monoethanol amine, diethanol amine, triethanol amine, morpholine, imidazole and the like;

a=0.01-0.8, preferably 0.01-0.6, and most preferably 0.01-0.5;

b=0.2-0.99, preferably 0.3-0.99, and most preferably 0.4-0.99;

c=0-0.5, preferably 0-0.3, and most preferably 0-0.1; and

wherein a, b, c represent the mole fraction of each unit and the sum of a, b, and c, is 1;

l) a random copolymer corresponding to the following Formula (VI) in free acid or salt form having the following types and numbers of monomer units:

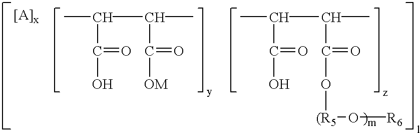

wherein A is selected from the moieties (i) and (ii)

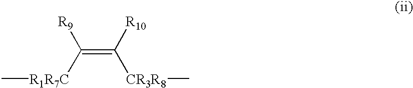

(i) —CR₁R₂—CR₃R₄—

wherein R₁ and R₃ are selected from substituted benzene, C₁₋₈ alkyl, C₂₋₈ alkenyl, C₂₋₈ alkylcarbonyl, C₁₋₈ alkoxy, carboxyl, and hydrogen, or R₁ and R₃ can together with R₂ and/or R₄ form a ring; and R₂ and R₄ are selected from the group consisting of hydrogen and C₁₋₄ alkyl;

R₇, R₈, R₉, and R₁₀ are individually selected from the group consisting of hydrogen, C₁₋₆ alkyl, or R₁ and R₃ together with R₇ and/or R₈, R₉, and R₁₀ form a continuous C₂₋₈ hydrocarbon chain joining the carbon atoms to which they are attached, the hydrocarbon chain optionally having at least one anionic group, preferably sulphonic;

M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;

R₅ is a C₂₋₈ alkylene radical;

R₆ is selected from the group consisting of C₁₋₂₀ alkyl, C₆₋₉ cycloalkyl and phenyl;

n, x, and z are numbers from 1 to 100;

y is 0 to 100;

m is 2 to 1000;

the ratio of x to (y+z) is from 1:10 to 10:1 and the ratio of y:z is from 5:1 to 1:100;

m) a copolymer based on oxyalkyleneglycol-alkenyl ethers and unsaturated dicarboxylic acid derivatives, comprising:

i) 10 to 90 mol % of component of the formula Ia and or Ib:

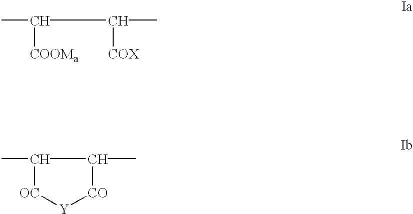

wherein M is a hydrogen atom, a mono- or divalent metal cation, an amonium ion or an organic amine residue, a is 1, or when M is a divalent metal cation is ½, X is —OMₐ or —O—(CₘH₂ₘO)ₙ—R₁, in which R₁ is a hydrogen atom, an aliphatic hydrocarbon radical containing from 1 to 20 carbon atoms, a cycloaliphatic hydrocarbon radical containing 5 to 8 carbon atoms or an optionally substituted aryl radical containing 6 to 14 carbon atoms, m is 2 to 4, n is 0 to 100,—NHR₂ and/or —N(R₂)₂, in which R₂═R₁ or —CO—NH₂, and Y is an oxygen atom or —NR₂;

ii) 1 to 89 mol % of components of the general formula:

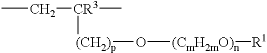

wherein R₃ is a hydrogen atom or an aliphatic hydrocarbon radical containing from 1 to 5 carbon atoms, p is 0 to 3, and R₁, m, and n have the above-given meanings, and

iii) 0.1 to 10 mol % of components of the general formulae:

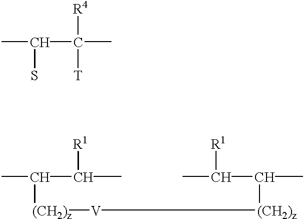

wherein S is a hydrogen atom or —COOMₐ or —COOR₅ , T is —COOR₅,

—W—R_{7,}—CO—[—NH—(CH2)3)-]ₛ—W—R_{7,}—CO—O—(CH₂)_{z}—W—R₇, a radical of the general formula:

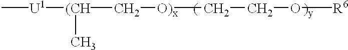

or —(CH₂)_{z}—V—(CH₂)_{z}—CH═CH—R₁, or when S is —COOR₅ or —COOMₐ, U₁ is —CO—NHM—, —O— or —CH₂O, U₂ is —NH—CO—, —O— or —OCH₂, V is —O—CO—C₆H₄—CO—O— or —W—, and W is

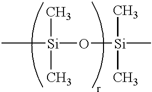

R₄ is a hydrogen atom or a methyl radical, R₅ is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or

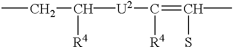

R₇═R₁ or

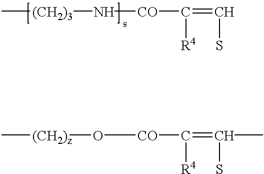

r is 2 to 100, s is 1 or 2, x is 1 to 150,y is o to 15and z is 0 to 4.

As used herein, the term cement refers to any hydraulic cement. Hydraulic cements are materials which set when mixed with water. Suitable examples of hydraulic cements include, but are not limited to, portland cement, masonry cement, alumina cement, refractory cement, magnesia cement, calcium sulfoaluminate cement, oil well cement, and mixtures thereof.

Pastes are defined as mixtures composed of a hydraulic cement binder, either alone or in combination with pozzolans such as fly ash, silica fume, or blast furnace slag, and water. Mortars are defined as pastes that additionally include fine aggregate. Concretes additionally include coarse aggregate.

A water soluble air controlling agent can be combined with a dispersant for cementitious compositions to form an admixture for cementitious compositions. The combination of a water soluble air controlling agent with a dispersant for cementitious compositions provides an admixture that is stable over time in that there is little or no phase separation between the dispersant and air controlling agent.

The amount of water soluble air controlling agent that is present in the admixture ranges from about 0.25 weight % to about 40 weight % based on the weight of the dispersant for cementitious compositions. Preferably, the amount of water soluble air controlling agent that is present in the admixture ranges from about 1 weight % to about 20 weight % based on the weight of the dispersant for cementitious compositions.

Examples of the water soluble air controlling agent include, but are not limited to, compounds of alkoxylated R, where R could be: a hydrocarbon, sorbitan, polypropylene oxide, fatty acid, fatty alcohol, or C₈-C₂₂ alkyl amine. The hydrocarbon preferably contains from 1 to about 22 carbons, and the fatty acid and fatty alcohol preferably contain from about 8 to about 22 carbon atoms. Preferred alkoxylates are molecules containing ethylene oxide and/or propylene oxide. Most preferred alkoxylates are molecules containing ethylene oxide. The water soluble air controlling agents can be used in combination with other water soluble air controlling agents. Specific examples of these types of water soluble air controlling agents include, but are not limited to those set forth below.

Block copolymers of ethylene oxide (EO) and propylene oxide (PO), such as PLURONIC® products available from BASF, are examples of water soluble air controlling agents. Standard PLURONIC® products are EO—PO—EO based copolymers. PLURONIC® products with an R in the product name are PO—EO—PO based. The basic structures are given below:

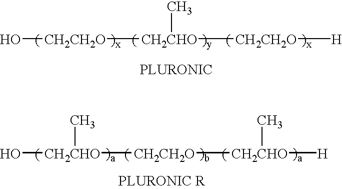

Specific PLURONIC® product names are based on the EO and PO content and the molecular weight. The specific product name indicates the molecular weight of the hydrophobe, the propylene oxide, and the percent of the hydrophile, the ethylene oxide, in the molecule. The first two digits multiplied by 300 gives the molecular weight, and the last digit multiplied by 10 gives the percent hydrophile. For PLURONIC® R products, the numbers before the R multiplied by 100 gives the molecular weight of the combined PO blocks, and the number after the R multiplied by 10 gives the EO percentage. The solubility of the polymer is based on the HLB value. Generally, as the HLB value increases the ability of the polymer to be solubilized by making micelles increases.

The SURFYNOL® 400 series of products are acetylenic diols. The last two digits of the product number indicate the percentage of ethylene oxide by weight. Some of the SURFYNOL® 400 series of products are water insoluble; however, SURFYNOL® 465 and SURFYNOL® 485 are water soluble. The basic structure of SURFYNOL® 400 series products is given by the following structure:

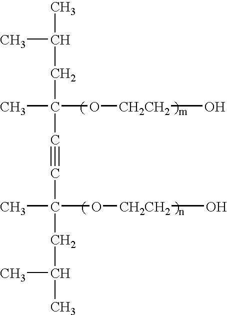

TERGITOL® NP, from Union Carbide Company, is a polymer of ethylene oxide and nonylphenol (ethoxylated nonylphenol) and is represented by the following structure:

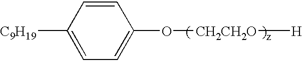

JEFFOX® chemicals, from Huntsman Chemical Company, are mono alkyl polyoxyalkylenes. Preferred is a 50/50 ethylene oxide/propylene oxide random polymer with a mono-butyl terminal group [Bu—O—(PO)ₓ(EO)ₓ—H].

One measure of a product's emulsification characteristics is the hydrophile lipophile balance (HLB). As the HLB increases, there are more hydrophilic groups in the surfactant and the more the surfactant is water soluble. Generally, an HLB of 3-6 indicates a water in oil emulsifier, an HLB of 7-9 indicates a wetting agent, an HLB of 8-18 indicates an oil in water emulsifier, an HLB of 13-15 indicates a detergent, and an HLB of 15-22 indicates a solubilizer. The following references provide more information about HLB: The Atlas HLB System, 4^{th} printing, Wilmington, Del., Atlas Chemical Industries, 1963; “Emulsions”, Ullmans's Encyclopedia of Industrial Chemistry, 5^{th} ed 1987; Fox, C., “Rationale for the Selection of Emulsifying Agents”, Cosmetics & Toiletries 101.11 (1986), 25-44; Graciaa, A., J. Lachaise, and G. Marion, “A Study of the Required Hydrophile-Lipophile Balance for Emulsification”, Langmuir 5 (1989):1215-1318; and Griffin, W. C. “Emulsions”, Kirk Othmer Encyclopedia of Chemical Technology, 3^{rd} ed 1979.

Generally, materials with an HLB up to 4 have strong defoaming properties. As the HLB value increases, the defoaming capabilities decrease and foaming capabilities increase. In the present invention, the air controlling agents generally have an HLB value ranging from about 5 to about 22.

The admixture of the present invention can be used in combination with any other admixture or additive for cement. Other cement admixtures and additives include, but are not limited to, set retarders, set accelerators, air-entraining or air detraining agents, corrosion inhibitors, any other dispersants for cement, pigments, wetting agents, water soluble polymers, strength enhancing agents, rheology modifying agents, water repellents, and any other admixture or additive that does not adversely affect the properties of the admixture of the present invention.

Other dispersants for cement include, but are not limited to, calcium lignosulfonates, beta naphthalene sulfonates, sulfonated melamine formaldehyde condensates, and any other chemical that functions as a dispersant or water reducer or superplasticizer for cement, and mixtures thereof.

Listed below are several examples of admixtures and additives that can be used with the present invention. U.S. Pat. No. 5,728,209 to Bury et al., which is incorporated herein by reference, contains a detailed description of different types of admixtures.

The term air entrainer includes any chemical that will entrain air in cementitious compositions. Air entrainers can also reduce the surface tension of a composition at low concentration. Air-entraining admixtures are used to purposely entrain microscopic air bubbles into concrete. Air-entrainment dramatically improves the durability of concrete exposed to moisture during cycles of freezing and thawing. In addition, entrained air greatly improves a concrete's resistance to surface scaling caused by chemical deicers. Air entrainment also increases the workability of fresh concrete while eliminating or reducing segregation and bleeding. Materials used to achieve these desired effects can be selected from salts of wood resin; (Vinsol resin); some synthetic detergents; salts of sulfonated lignin; salts of petroleum acids; salts of proteinaceous material; fatty and resinous acids and their salts; alkylbenzene sulfonates; and salts of sulfonated hydrocarbons. Air entrainers are added in an amount to yield a desired level of air in a cementitious composition. Generally, the amount of air entrainers in a cementitious composition ranges from about 0.2 to about 5.0 fluid ounces per hundred pounds of cement. But this can vary widely due to variations in materials, mix proportion, temperature, and mixing action.

Retarding, or delayed-setting, admixtures are used to retard, delay, or slow the rate of setting of concrete. They can be added to the concrete mix upon initial batching or sometime after the hydration process has begun. Retarders are used to offset the accelerating effect of hot weather on the setting of concrete, or delay the initial set of concrete or grout when difficult conditions of placement occur, or problems of delivery to the job site, or to allow time for special finishing processes or to aid in the reclamation of concrete left over at the end of the work day. Most retarders also act as water reducers and can also be used to entrain some air into concrete. Lignosulfonates, hydroxylated carboxylic acids, lignin, borax, gluconic, tartaric and other organic acids and their corresponding salts, phosphonates, certain carbohydrates and mixtures thereof can be used as retarding admixtures.

Air detrainers are used to decrease the air content in the mixture of concrete. Tributyl phosphate, dibutyl phthalate, octyl alcohol, water-insoluble esters of carbonic and boric acid, and silicones are some of the common materials that can be used to achieve this effect.

Alkali-reactivity reducers can reduce the alkali-aggregate reaction and limit the disruptive expansion forces in hardened concrete. Pozzolans (fly ash, silica fume), blast-furnace slag, salts of lithium and barium are especially effective.

Bonding admixtures are usually added to portland cement mixtures to increase the bond strength between old and new concrete and include organic materials such as rubber, polyvinyl chloride, polyvinyl acetate, acrylics, styrene butadiene copolymers, and other powdered polymers.

Water-reducing admixtures are used to reduce the amount of mixing water required to produce concrete of a certain slump, to reduce the ratio of water and cement, or to increase slump. Typically, water reducers will reduce the water content of the concrete mixture by approximately up to 15%.

Superplasticizers are high-range water reducers, or water-reducing admixtures. They are added to concrete to make high-slump, flowing concrete, and thus reduce the water-cement ratio. These admixtures produce large water reduction or great flowability without causing undue set retardation or entrainment of air in mortar or concrete. Among the materials that can be used as superplasticizers are sulfonated melamine formaldehyde condensates, sulfonated naphthalene formaldehyde condensates, certain organic acids, lignosulfonates, and/or blends thereof.

Natural and synthetic admixtures are used to color concrete for aesthetic and safety reasons. These coloring admixtures are usually composed of pigments and include carbon black, iron oxide, phthalocyanine, umber, chromium oxide, titanium oxide and cobalt blue.

Corrosion inhibitors in concrete serve to protect embedded reinforcing steel from corrosion due to its highly alkaline nature. The high alkaline nature of the concrete causes a passive and noncorroding protective oxide film to form on the steel. However, carbonation or the presence of chloride ions from deicers or seawater can destroy or penetrate the film and result in corrosion. Corrosion-inhibiting admixtures chemically arrest this corrosion reaction. The materials most commonly used to inhibit corrosion are calcium nitrite, sodium nitrite, sodium benzoate, certain phosphates or fluorosilicates, fluoroaluminates, amines, organic based water repelling agents, and related chemicals.

Dampproofing admixtures reduce the permeability of concrete that have low cement contents, high water-cement ratios, or a deficiency of fines in the aggregate. These admixtures retard moisture penetration into dry concrete and include certain soaps, stearates, and petroleum products.

Grouting agents, such as air-entraining admixtures, accelerators, retarders, and non-shrink and workability agents, adjust grout properties to achieve a desired result for specific applications. For example, portland cement grouts are used for a variety of different purposes, each of which may require a different agent to stabilize foundations, set machine bases, fill cracks and joints in concrete work, cement oil wells, fill cores of masonry walls, and grout pre-stressing tendons and anchor bolts, and fill the voids in pre-placed aggregate concrete.

Gas formers, or gas-forming agents, are sometimes added to concrete and grout in very small quantities to cause a slight expansion prior to hardening. The amount of expansion is dependent upon the amount of gas-forming material used and the temperature of the fresh mixture. Aluminum powder, resin soap and vegetable or animal glue, saponin or hydrolyzed protein can be used as gas formers.

Permeability reducers are used to reduce the rate at which water under pressure is transmitted through concrete. Silica fume, fly ash, ground slag, natural pozzolans, water reducers, and latex can be employed to decrease the permeability of the concrete. Pozzolan is a siliceous or siliceous and aluminous material, which in itself possesses little or no cementitious value. However, in finely divided form and in the presence of moisture, pozzolan will chemically react with calcium hydroxide at ordinary temperatures to form compounds possessing cementitious properties.

Pumping aids are added to concrete mixes to improve pumpability. These admixtures thicken the fluid concrete, i.e., increase its viscosity, to reduce de-watering of the paste while it is under pressure from the pump. Among the materials used as pumping aids in concrete are organic and synthetic polymers, hydroxyethylcellulose (HEC) or HEC blended with dispersants, organic flocculents, organic emulsions of paraffin, coal tar, asphalt, acrylics, bentonite and pyrogenic silicas, natural pozzolans, fly ash and hydrated lime.

Bacteria and fungal growth on or in hardened concrete may be partially controlled through the use of fungicidal, germicidal, and insecticidal admixtures. The most effective materials for these purposes are polyhalogenated phenols, dialdrin emulsions, and copper compounds.

Fresh concrete can sometimes be harsh because of faulty mixture proportions or certain aggregate characteristics such as particle shape and improper grading. Under these conditions, entrained air which acts like a lubricant, can be used as a workability improving agent. Other workability agents are water reducers and certain finely divided admixtures.

Finely divided mineral admixtures are materials in powder or pulverized form added to concrete before or during the mixing process to improve or change some of the plastic or hardened properties of portland cement concrete. Portland cement, as used in the trade, means a hydraulic cement produced by pulverizing clinker, consisting essentially of hydraulic calcium silicates, all usually containing one or more of the forms of calcium sulfate as an interground addition with ASTM types, I, II, III, IV, or V. The finely divided mineral admixtures can be classified according to their chemical or physical properties as: cementitious materials; pozzolans; pozzolanic and cementitious materials; and nominally inert materials. Cementitious materials are materials that alone have hydraulic cementing properties, and set and harden in the presence of water. Included in cementitious materials are ground granulated blast-furnace slag, natural cement, hydraulic hydrated lime, and combinations of these and other materials. As discussed above, pozzolan is a siliceous or aluminosiliceous material that possesses little or no cementitious value but will, in the presence of water and in finely divided form, chemically react with the calcium hydroxide released by the hydration of portland cement to form materials with cementitious properties. Diatomaceous earth, opaline cherts, clays (including calcined clays), shales, fly ash, silica fume, volcanic tuffs and pumicites are some of the known pozzolans. Certain ground granulated blast-furnace slags and high calcium fly ashes possess both pozzolanic and cementitious properties. Natural pozzolan is a term of art used to define the pozzolans that occur in nature, such as volcanic tuffs, pumices, trasses, diatomaceous earths, opaline, cherts, and some shales. Nominally inert materials can also include finely divided raw quartz, dolomites, limestones, marble, granite, and others. Fly ash is defined in ASTM C-618.

In the construction field, many methods of strengthening concrete have been developed through the years. One modern method involves distributing fibers throughout a fresh concrete mixture. Upon hardening, this concrete is referred to as fiber-reinforced concrete. Fibers can be made of zirconium materials, steel, fiberglass, or synthetic materials, e.g., polypropylene, nylon, polyethylene, polyester, rayon, high-strength aramid, (i.e. KEVLAR®), or mixtures thereof.

A cementitious composition can be formed which comprises cement, water, and a water soluble air controlling agent and a dispersant for cementitious compositions. The cementitious composition can also include fine aggregates, coarse aggregates, pozzolans, air (either entrapped or purposefully entrained), clay, and pigments.

The fine aggregates are materials that pass through a Number 4 sieve (ASTM C₁₂₅ and ASTM C₃₃), such as natural or manufactured sand. The coarse aggregates are materials that are retained on a Number 4 sieve (ASTM C₁₂₅ and ASTM C₃₃), such as silica, quartz, crushed round marble, glass spheres, granite, limestone, calcite, feldspar, alluvial sands, or any other durable aggregate, and mixtures thereof.

A method of controlling air in a cementitious composition is also provided which comprises mixing cement, water, a water soluble air controlling agent, and a dispersant for cementitious compositions.

The amount of water added to the cementitious composition is calculated based on a desired water to cement (W/C) ratio. The water to cement ratio typically ranges from about 0.2 to about 0.7 with the water and cement being measured by weight.

The air controlling agent can be added to a cementitious composition separately or it can be included with an admixture which is added to the cementitious composition, such as with the dispersant for cementitious compositions.

### SPECIFIC EMBODIMENTS OF THE INVENTION

Samples of cementitious compositions were prepared using a polycarboxylate dispersant, comprising a polymeric carboxylate backbone with polyether side chains, and tested as detailed below.

The following tests were used: Slump (ASTM C₁₄₃), Air content (ASTM C₂₃₁), Set time (ASTM C₄₀₃), % Flow (ASTM C-230). Aggregates met the specifications of ASTM C₃₃. The term W/C refers to the water to cement ratio in a cementitious mixture. The term S/A refers to the sand to aggregate ratio by volume.

Air entraining agents used in the following examples were MB AE® 90 or MB VR® from Master Builders, Inc., Cleveland, Ohio.

Typical properties of the air controlling agents (ACA) used in the examples below are:

| | | Water |
|---|---|---|
| Air controlling agent | HLB | Solubility |
| Polyoxyalkylene-PLURONIC ® L-61 | 3 | insoluble |
| Polyoxyalkylene-PLURONIC ® L-31 | 5 | soluble > 10% |
| Polyoxyalkylene-PLURONIC ® 17R2 | 6 | soluble > 10% |
| Polyoxyalkylene-PLURONIC ® L-43 | 12 | soluble > 10% |
| Ethoxylated acetylenic diol-SURFYNOL ® 420 | 4 | insoluble |
| Ethoxylated acetylenic diol-SURFYNOL ® 440 | 8 | slightly |
| | | soluble < 1% |
| Ethoxylated acetylenic diol-SURFYNOL ® 465 | 13 | soluble > 1% |
| Alkyl aryl alkoxylate-TERGITOL ® NP-6 | 10.9 | soluble |
| Mono alkyl polyoxyethylene (MW 1400) | N/A | soluble > 10% |
| Mono alkyl polyoxyethylene (MW 2400) | N/A | soluble > 10% |

### EXAMPLE 1

Different polyoxyalkylene additives ranging in HLB from 1 to 19, listed below in Table 1, were tested in combination with a polycarboxylate dispersant. The reference dispersant was a polymeric carboxylate backbone with polyether side chains. The dispersant was added at 0.2 grams per hundred grams of cement. The amount of polyoxyalkylene additive was based on the active amount of dispersant added and was 1% for all mixtures.

The mortar mix contained 540g of Medusa Type I cement, 1455 grams of sand, and 190 grams of water. The W/C ratio was 0.35. The results are listed below in Table 1.

TABLE 1

| | | | Flow (%) | | | Air (%) | | |
|---|---|---|---|---|---|---|---|---|
| Mix | ACA | HLB | 3 min | 6 min | 9 min | 3 min | 6 min | 9 min |
| 1-1 | No ACA | N/A | 98 | 99 | 94 | 16.7 | 18.9 | 18.5 |
| 1-2 | PLURONIC ® L-101 | 1 | 110 | 103 | 86 | 1.8 | 2.6 | 3.0 |
| 1-3 | PLURONIC ® L-81 | 2 | 111 | 97 | 84 | 1.7 | 1.9 | 1.9 |
| 1-4 | PLURONIC ® L-61 | 3 | 104 | 97 | 80 | 1.3 | 2.1 | 1.7 |
| 1-5 | PLURONIC ® L-31 | 5 | 113 | 104 | 80 | 1.5 | 1.7 | 1.7 |
| 1-6 | PLURONIC ® 17R2 | 7 | 110 | 99 | | 1.7 | 1.5 | |
| 1-7 | PLURONIC ® L-10 | 14 | 109 | 99 | 85 | 2.5 | 3.0 | 3.4 |
| 1-8 | PLURONIC ® L-35 | 19 | 120 | 116 | 108 | 10.4 | 12.2 | 10.9 |

The results shown in Table 1 demonstrate that materials with HLB values as high as 19 reduce air contents in cementitious mixtures containing polycarboxylate dispersants, and that materials with HLB values ≧5, which are beyond the range generally expected for defoamers, unexpectedly reduce air content in non-air entrained mixtures to acceptable levels. In addition, air contents do not significantly change with mix time and this produces predictable performance in practice.

### EXAMPLE 2

Different polyoxyalkylenes ranging in HLB from 1 to 14, listed below in Table 2, were tested in combination with a polycarboxylate dispersant and an air entraining agent, MB VR®. The reference dispersant was a polymeric carboxylate backbone with polyether side chains. The dispersant was added at 0.2 grams per hundred grams of cement. The amount of polyoxyalkyelene was based on the active amount of dispersant added and was 1% for all mixtures. The air entrainer amount was present at about one ounce per hundred weight of cement.

The mortar mix design contained 540g of Medusa Type I cement, 1455 grams of sand, and 190 grams of water. The W/C ratio was 0.35. The results are listed below in Table 2.

TABLE 2

| | Admixture with ACA, | | Flow (%) | | | Air (%) | | |
|---|---|---|---|---|---|---|---|---|
| | dispersant, and air entrainer | | 3 | 6 | 9 | 3 | 6 | 9 |
| Mix | (AE) | HLB | min | min | min | min | min | min |
| 2-1 | No ACA or AE | N/A | 107 | 107 | 100 | 19.7 | 19.9 | 18.8 |
| 2-2 | No ACA | N/A | 97 | 96 | 94 | 29.1 | 30.3 | 29.1 |
| 2-3 | PLURONIC ® L-101 | 1 | 105 | 96 | 94 | 19.8 | 28.4 | 29.2 |
| 2-4 | PLURONIC ® L-61 | 3 | 124 | 110 | 94 | 6.6 | 7.1 | 6.5 |
| 2-5 | PLURONIC ® L-31 | 5 | 105 | 109 | 101 | 14.5 | 15.5 | 13.8 |
| 2-6 | PLURONIC ® 17R2 | 7 | 108 | 101 | 91 | 7.2 | 7.8 | 7.2 |
| 2-7 | PLURONIC ® L-43 | 12 | 112 | 104 | 100 | 19.6 | 20.5 | 19.9 |
| 2-8 | PLURONIC ® L-10 | 14 | 118 | 109 | 99 | 13.1 | 13.9 | 11.2 |
| 2-9 | PLURONIC ® L-10 without | 14 | 116 | 108 | 85 | 2.6 | 2.3 | 3.5 |
| | AE | | | | | | | |

Mix 2-1 shows high and stable air contents over time due to the polycarboxylate dispersant. Mix 2-2 shows that the combination of polycarboxylate dispersant and air entrainer produces even higher air contents that are stable over time. Mix 2-3 demonstrates unstable air contents over time in the presence of an air-entrainer and an insoluble, low HLB defoaming agent. The other mix results demonstrate that with higher HLB air controlling agents, stable and predictable air contents can be achieved with the combination of polycarboxylate dispersant and air entraining agent.

Examples 3, 4, and 5 contain the results for air controlling agents in non-air entrained concrete. Concrete mixture proportions for the examples shown in Table 3 contained 658 lb./yd³ cement content using a Type I portland cement, a sand:aggregate ratio (S/A) of 0.429 using limestone coarse aggregate, sand, and sufficient water to obtain a slump of 6″ to 8″. Concrete mixture proportions for the examples shown in Tables 4 and 5 contained a 600 lb./yd³ cement content using a Type I portland cement, a S/A of 0.433 using limestone coarse aggregate, sand, and sufficient water to obtain a slump of 6″ to 8″.

Examples 6 and 7 contain the results for air controlling agents in purposefully air-entrained concrete. Concrete mixture proportions contained a 600 lb./yd³ cement content using a Type I portland cement, a S/A ratio of 0.440 using limestone coarse aggregate, sand, and sufficient water to obtain a slump of 6″ to 8″.

### EXAMPLE 3

Air controlling agents were tested at different levels in combination with a polycarboxylate dispersant. The reference dispersant was a polymeric carboxylate backbone with polyether side chains. The dispersant was added at 0.29 lbs. per hundred weight of cement. The types of air controlling agent tested were polyoxyalkylenes ranging in HLB from 1 to 12, PLURONIC® L-101, PLURONIC® L-61, PLURONIC® 17R₂, and PLURONIC® L-43 from BASF, and a soluble alkyl aryl alkoxylate, TERGITOL® NP-6 from Union Carbide Company. The amount of air controlling agent was based on the active amount of dispersant added. The dispersant and the other air controlling agents were added with the sand, except 3-6 and 3-7, which were added with the water. The results are listed below in Table 3.

TABLE 3

| | | | W/C | Slump | Air | Compressive Strength (psi) | | |
|---|---|---|---|---|---|---|---|---|
| Mix | Admixture | HLB | ratio | (inches) | (%) | 1 day | 7 days | 28 days |
| 3-1 | Dispersant only | | 0.334 | 9.25 | 8.5 | 2540 | 5400 | 6490 |
| 3-2 | Dispersant + | 7 | 0.334 | 9.25 | 1.4 | 3250 | 6550 | 6980 |
| | 17R2@1% | | | | | | | |
| 3-3 | Dispersant + | 12 | 0.334 | 9 | 1.8 | 3325 | 5770 | 9040 |
| | L43@2% | | | | | | | |
| 3-4 | Dispersant + | 1 | 0.334 | 9 | 1.4 | 3360 | 6720 | 7970 |
| | L101@1% | | | | | | | |
| 3-5 | Dispersant + | 3 | 0.334 | 8.75 | 1.6 | 3230 | 6740 | 8250 |
| | L61@1% | | | | | | | |
| 3-6 | Dispersant + | 10.9 | 0.334 | 8.75 | 1.8 | 3030 | 6590 | 7540 |
| | NP-6@1% | | | | | | | |

The results in Table 3 show that the polyoxyalkylene and alkyl aryl alkoxylate type air controlling agents can effectively lower the air content of a concrete mixture containing a polycarboxylate dispersant. Similar to the results found in Example 1, the soluble air controlling agents having an HLB≧5 were equally and unexpectedly as effective at lowering the air as traditional defoamers having an HLB≦4.

### EXAMPLE 4

Air controlling agents were tested at different levels in combination with a polycarboxylate dispersant. The reference dispersant was a polymeric carboxylate backbone with polyether side chains. The dispersant was added at 0.2 lbs. per hundred weight of cement. The types of air controlling agent tested were polyoxyalkylenes ranging in HLB from 5 to 12 (PLURONIC® L-31, PLURONIC® 17R₂, and PLURONIC® L-43 from BASF) and mono alkoxyalkoxylates (JEFFOX® WL-5000 and JEFFOX® WL-660 from Huntsman Chemical Co). Two insoluble defoamers, a polyoxyalkylene, PLURONIC® L-61 (HLB=3), and SURFYNOL® DF-75, (a non-silicone proprietary mixture) from Air Products and Chemicals, Inc., were included for comparison. The amount of air controlling agent stated was based on the active amount of dispersant added, and the dispersant and air controlling agent were added together with the water. The composition test results are listed below in Table 4.

TABLE 4

| | | | | | Compressive | | |
|---|---|---|---|---|---|---|---|
| | | W/C | Slump | Air | Strength (psi) | | |
| Mix | Admixture | ratio | (inches) | (%) | 1 day | 7 days | 28 days |
| 4-1 | Plain | 0.525 | 7.25 | 1.1 | 1360 | 3980 | 5960 |
| 4-2 | Dispersant | 0.363 | 7.75 | 4.2 | 2640 | 5710 | 7380 |
| 4-3 | Dispersant + | 0.367 | 7.75 | 1.9 | 2940 | 6440 | 8440 |
| | L31@1% | | | | | | |
| 4-4 | Dispersant + | 0.360 | 7.5 | 2.6 | 2870 | 6100 | 7780 |
| | L31@0.25% | | | | | | |
| 4-5 | Dispersant + | 0.363 | 6.25 | 2.3 | 3050 | 6830 | 8680 |
| | L61@1% | | | | | | |
| 4-6 | Dispersant + | 0.363 | 7.5 | 3.3 | 2910 | 5630 | 8210 |
| | L61@0.25% | | | | | | |
| 4-7 | Dispersant + | 0.363 | 7 | 2.5 | 2830 | 6700 | 8250 |
| | 17R2@1% | | | | | | |
| 4-8 | Dispersant + | 0.360 | 8.5 | 7.2 | 2670 | 5870 | 7050 |
| | 17R2@0.25% | | | | | | |
| 4-9 | Dispersant + | 0.363 | 7.5 | 2.8 | 3210 | 6090 | 8010 |
| | L43@1% | | | | | | |
| 4-10 | Dispersant + | 0.363 | 8 | 2.6 | 2720 | 6210 | 7990 |
| | WL5000@4% | | | | | | |
| 4-11 | Dispersant + | 0.363 | 8 | 2.1 | 2660 | 6010 | 7880 |
| | WL660@4% | | | | | | |
| 4-12 | Dispersant + | 0.367 | 7.75 | 1.9 | 2720 | 6370 | 8020 |
| | DF-75@0.5% | | | | | | |

Example 4 shows a comparison of air controlling agents and insoluble defoamers in non-air-entrained cementitious mixtures. Unexpectedly, the soluble air controlling agent/polycarboxylate admixtures (4-3, 4-4, 4-7, 4-8, 4-9, 4-10, 4-11) performed as effectively as the known insoluble defoamer/dispersant combination. However, the soluble air controlling agent/polycarboxylate dispersant admixtures are more stable over time as compared to the insoluble defoamer mixtures.

### EXAMPLE 5

Air controlling agents were tested at different levels in combination with a polycarboxylate dispersant. The reference dispersant was a polymeric carboxylate backbone with polyether side chains. The dispersant was added at 0.2 lbs. per hundred weight of cement. The type of air controlling agent tested was an ethoxylated acetylenic diol, SURFYNOL® 465, compared to insoluble defoamers SURFYNOL® 420, and SURFYNOL® 440, from Air Products and Chemicals, Inc. The dispersant and air controlling agent or defoamer were added together with the water. The amount of air controlling agent or defoamer was based on the active amount of dispersant added. The SURFYNOL® 440 and 465 were stirred into the dispersant. The SURFYNOL® 420 was dispersed into the dispersant using a high shear propeller mixer operating at 1300 rpm for 2 minutes. The test results are listed below in Table 5.

TABLE 5

| | | | | | Compressive | | |
|---|---|---|---|---|---|---|---|
| | | W/C | Slump | Air | Strength (psi) | | |
| Mix | Admixture | ratio | (inches) | (%) | 1 day | 7 days | 28 days |
| 5-1 | Plain | 0.514 | 7.25 | 0.9 | 1300 | 4100 | 5970 |
| 5-2 | Dispersant | 0.332 | 8 | 3.7 | | | |
| 5-3 | Dispersant + | 0.339 | 7.75 | 1.9 | 3380 | 6670 | 8180 |
| | 420@1% | | | | | | |
| 5-4 | Dispersant + | 0.332 | 8.25 | 2.9 | 3070 | 5950 | 7340 |
| | 420@0.5% | | | | | | |
| 5-5 | Dispersant + | 0.343 | 7.75 | 1.4 | 3450 | 6560 | 8350 |
| | 440@1% | | | | | | |
| 5-6 | Dispersant + | 0.336 | 8 | 1.7 | 3290 | 6560 | 8330 |
| | 440@0.5% | | | | | | |
| 5-7 | Dispersant + | 0.343 | 8 | 2.2 | 3310 | 6340 | 8090 |
| | 465@1% | | | | | | |
| 5-8 | Dispersant + | 0.343 | 8.25 | 2.1 | 3360 | 6480 | 8120 |
| | 465@0.5% | | | | | | |

Example 5 shows a comparison of acetylenic diol air controlling agents with various degrees of solubility. The insoluble defoamer and soluble air controlling agents performed similarly. Unexpectedly, the soluble air controlling agent/polycarboxylate admixtures (5-7 and 5-8) performed as effectively as the known insoluble defoamer/dispersant combination. However, the soluble air controlling agent/polycarboxylate dispersant admixtures are more stable over time as compared to the insoluble defoamer mixtures.

The results in Tables 3, 4, and 5 demonstrate that any number of soluble polyoxyalkylenes, mono alkyl polyoxyalkylenes, or alkyl aryl alkoxylates may be used to control air contents of non-air entrained concrete mixtures containing a polycarboxylate dispersant.

### EXAMPLES 6-1 Through 6-6

Cement mixes were prepared that varied the amount of an insoluble polyoxyalkylene defoamer (HLB=3), PLURONIC® L-61, and the amount and type of an air entraining agent. The air entraining agents were proprietary mixtures MB VR® or MB AE® 90 from Master Builders, Inc. The air entrainer amounts are listed as fluid ounces per hundred weight of cement. All samples contained a dispersant, which comprised a polymeric carboxylate backbone with polyether side chains. The dispersant was added at 0.2 lbs. per hundred weight of cement. The amount of defoamer was based on the active amount of dispersant added. The dispersant and defoamer were added together with the water, and the air entraining agent was added with the sand. The test results are listed below in Table 6.

Examples 6-1 to 6-6 show the performance of a defoamer that demonstrates desired performance characteristics in air-entrained concrete; however, it is insoluble. The mixtures had typical dosages of air-entraining agents, which were stable over time.

### EXAMPLES 6-7 To 6-12

Concrete mixes were prepared that varied the amount of soluble polyoxyalkylene (HLB=5) air controlling agent, PLURONIC® L-31, the amount of air entraining agent, MB AE® 90, and the amount of dispersant. The air entrainer amount is listed as fluid ounces per hundred weight of cement. The dispersant was a polymeric carboxylate backbone with polyether side chains. The amount of air controlling agent was based on the active amount of dispersant added. The dispersant and air controlling agent were added together with the water and the air entraining agent was added with the sand, except for Mix 6-12, which had the air entrainer added first, then the dispersant and air controlling agent added two minutes later. The test results are listed below in Table 6.

### EXAMPLES 6-13 To 6-17

Concrete mixes were prepared with the same air controlling agent as in examples 6-7 to 6-12and a lower dosage of air entraining agent, MB AE® 90, and a varied amount of dispersant. A second air entrainer, MB VR®, was included for comparison. The air entrainer amounts are listed as fluid ounces per hundred weight of cement. The dispersant was a polymeric carboxylate backbone with polyether side chains. The amount of air controlling agent was based on the active amount of dispersant added. The dispersant and air controlling agent were added together with the water and the air entraining agent was added with the sand. The test results are listed below in Table 6.

### EXAMPLES 6-18 To 6-23

Concrete mixes were prepared that varied the amount of soluble polyoxyalkylene air controlling agent (HLB 12), PLURONIC® L-43, and the amount of an air entraining agent, MB AE® 90. The air entrainer amount is listed as fluid ounces per hundred weight of cement. All samples contained a dispersant, which was a polymeric carboxylate backbone with polyether side chains. The dispersant was added at 0.2 lbs. per hundred weight of cement. The amount of air controlling agent was based on the active amount of dispersant added. The dispersant and air controlling agent were added together with the water. The air entraining agent was added with the sand. The test results are listed below in Table 6.

### EXAMPLES 6-24 To 6-28

Concrete mixes were prepared that varied the amount of soluble polyoxyalkylene air controlling agent (HLB=7), PLURONIC® 17R₂, and the amount of an air entraining agent, MB AE® 90. The air entrainer amount is listed as fluid ounces per hundred weight of cement. All samples contained a dispersant, which was a polymeric carboxylate backbone with polyether side chains. The dispersant was added at 0.2 lbs. per hundred weight of cement. The amount of air controlling agent was based on the active amount of dispersant added. The dispersant and air controlling agent were added together with the water and the air entraining agent was added with the sand. The test results are listed below in Table 6.

### EXAMPLES 6-29 To 6-32

Concrete mixes were prepared that varied the amount of soluble polyoxyalkylene air controlling agent (HLB=15), PLURONIC® L-64, and the amount of air entraining agent, MB AE 90, and the amount of dispersant. The air entrainer amount is listed as fluid ounces per hundred weight of cement. The dispersant was a polymeric carboxylate backbone with polyether side chains. The amount of air controlling agent was based on the active amount of dispersant added. The dispersant and air controlling agent were added together with the water and the air entraining agent was added with the sand. The test results are listed below in Table 6.

TABLE 6

| | | | Slump (inches) | | | Air (%) | | |
|---|---|---|---|---|---|---|---|---|
| | | W/C | 5 | 10 | 15 | 5 | 10 | 15 |
| Mix | Admixture | ratio | min | min | min | min | min | min |
| 6-1 | ACA-2% | 0.358 | 6.25 | 5 | 3.5 | 7.2 | 8.3 | 7.5 |
| | MB AE ® | | | | | | | |
| | 90-0.9 | | | | | | | |
| 6-2 | ACA-4% | 0.358 | 8 | 7.25 | 3.5 | 6.1 | 7.1 | 6.4 |
| | MB AE ® | | | | | | | |
| | 90-0.9 | | | | | | | |
| 6-3 | ACA-6% | 0.358 | 8.25 | 6.25 | 3.75 | 4.7 | 5.4 | 5.4 |
| | MB AE ® | | | | | | | |
| | 90-0.9 | | | | | | | |
| 6-4 | ACA-2% | 0.351 | 8.25 | 7.25 | 3 | 5.6 | 6.2 | 5.0 |
| | MB AE ® | | | | | | | |
| | 90-0.45 | | | | | | | |
| 6-5 | ACA-6% | 0.343 | 8.25 | 7.25 | 3.5 | 4.6 | 5.9 | 6.6 |
| | MB AE ® | | | | | | | |
| | 90-1.35 | | | | | | | |
| 6-6 | ACA-4% | 0.358 | 8.25 | 7.5 | 3.75 | 4.8 | 5.2 | 4.6 |
| | MB VR ® -0.9 | | | | | | | |
| 6-7 | No dispersant | 0.513 | 8 | | | 7.2 | | |
| | No ACA | | | | | | | |
| | MB AE ® | | | | | | | |
| | 90-1.2 | | | | | | | |
| 6-8 | Dispersant-0.2 | 0.361 | 7.5 | 6.75 | 5.25 | 9.3 | 11.0 | 10.5 |
| | ACA-2% | | | | | | | |
| | MB AE ® | | | | | | | |
| | 90-0.9 | | | | | | | |
| 6-9 | Dispersant-0.2 | 0.368 | 8.25 | 7 | 4.25 | 8.2 | 12.0 | 10.4 |
| | ACA-4% | | | | | | | |
| | MB AE ® | | | | | | | |
| | 90-0.9 | | | | | | | |
| 6-10 | Dispersant-0.08 | 0.469 | 7.75 | 6.5 | 5.5 | 8.4 | 8.5 | 7.4 |
| | ACA-6.538% | | | | | | | |
| | MB AE ® | | | | | | | |
| | 90-0.7 | | | | | | | |
| 6-11 | Dispersant-0.08 | 0.443 | 8.25 | 6.5 | 4.75 | 10.1 | 8.7 | 7.4 |
| | ACA-13.09% | | | | | | | |
| | MB AE ® | | | | | | | |
| | 90-0.7 | | | | | | | |
| 6-12 | Dispersant-0.08 | 0.458 | 9 | 7.75 | 6 | 8.5 | 9.0 | 7.6 |
| | ACA-6.538% | | | | | | | |
| | MB AE ® | | | | | | | |
| | 90-0.7 | | | | | | | |
| 6-13 | Dispersant-0.2 | 0.366 | 8.5 | 5.5 | 3 | 5.8 | 7.4 | 6.6 |
| | ACA-2% | | | | | | | |
| | MB AE ® | | | | | | | |
| | 90-0.5 | | | | | | | |
| 6-14 | Dispersant-0.08 | 0.463 | 8.25 | 6 | 4.25 | 6.5 | 6.2 | 5.6 |
| | ACA-6.54% | | | | | | | |
| | MB AE ® | | | | | | | |
| | 90-0.45 | | | | | | | |
| 6-15 | Dispersant-0.2 | 0.369 | 8.5 | 7.5 | 4.25 | 7.7 | 9.5 | 8.6 |
| | ACA-2% | | | | | | | |
| | MB VR ® | | | | | | | |
| | 90-1.0 | | | | | | | |
| 6-16 | Dispersant-0.08 | 0.463 | 7.75 | 6.75 | 4.75 | 6.6 | 6.7 | 6.1 |
| | ACA-6.54% | | | | | | | |
| | MB VR ® | | | | | | | |
| | 90-0.7 | | | | | | | |
| 6-17 | Dispersant-0.2 | 0.369 | 8.5 | 7.5 | 5.75 | 7.6 | 9.8 | 9.2 |
| | ACA-2.62% | | | | | | | |
| | MB VR ® | | | | | | | |
| | 90-1 | | | | | | | |
| 6-18 | ACA-3% | 0.352 | 9.25 | 7 | 3.5 | 9.8 | 10.5 | 8.4 |
| | MB AE ® | | | | | | | |
| | 90-0.9 | | | | | | | |
| 6-19 | ACA-6% | 0.352 | 9.25 | 7.75 | 3.5 | 7.5 | 9.0 | 8.0 |
| | MB AE ® | | | | | | | |
| | 90-0.9 | | | | | | | |
| 6-20 | ACA-9% | 0.352 | 10 | 8.5 | 5.25 | 6.5 | 10.0 | 8.6 |
| | MB AE ® | | | | | | | |
| | 90-0.9 | | | | | | | |
| 6-21 | ACA-6% | 0.356 | 9.25 | 8.75 | 4.25 | 7.4 | 8.5 | 7.7 |
| | MB AE ® | | | | | | | |
| | 90-0.7 | | | | | | | |
| 6-22 | ACA-6% | 0.360 | 9.25 | 5.75 | 3 | 4.8 | 5.8 | 5.2 |
| | MB AE ® | | | | | | | |
| | 90-0.4 | | | | | | | |
| 6-23 | ACA-3% | 0.356 | 9.5 | 6.5 | 3 | 5.6 | 6.6 | 5.6 |
| | MB AE ® | | | | | | | |
| | 90-0.4 | | | | | | | |
| 6-24 | ACA-2% | 0.348 | 7.25 | 6.75 | 5.25 | 10.0 | 12.9 | 12.2 |
| | MB AE ® | | | | | | | |
| | 90-0.9 | | | | | | | |
| 6-25 | ACA-4% | 0.366 | 7.5 | 7 | 5.5 | 6.8 | 9.0 | 8.7 |
| | MB AE ® | | | | | | | |
| | 90-0.9 | | | | | | | |
| 6-26 | ACA-6% | 0.381 | 7.5 | 6 | 4.75 | 5.3 | 6.6 | 6.7 |
| | MB AE ® | | | | | | | |
| | 90-0.9 | | | | | | | |
| 6-27 | ACA-3% | 0.366 | 6 | 5.5 | 4 | 5.0 | 6.1 | 6.3 |
| | MB AE ® | | | | | | | |
| | 90-0.45 | | | | | | | |
| 6-28 | ACA-9% | 0.370 | 7 | 6.5 | 4 | 5.0 | 6.0 | 6.4 |
| | MB AE ® | | | | | | | |
| | 90-1.35 | | | | | | | |
| 6-29 | Dispersant-0.2 | 0.379 | 7.75 | 5 | 3.25 | 5.9 | 6.5 | 5.9 |
| | ACA-9% | | | | | | | |
| | MB AE ® | | | | | | | |
| | 90-0.9 | | | | | | | |
| 6-30 | Dispersant-0.08 | 0.433 | 8 | 7 | 4 | 9.5 | 9.0 | 7.7 |
| | ACA-29% | | | | | | | |
| | MB AE ® | | | | | | | |
| | 90-0.9 | | | | | | | |
| 6-31 | Dispersant-0.08 | 0.440 | 8 | 7.5 | 3.75 | 7.8 | 6.2 | 5.3 |
| | ACA-29% | | | | | | | |
| | MB AE ® | | | | | | | |
| | 90-0.55 | | | | | | | |
| 6-32 | Dispersant-0.2 | 0.367 | 8.5 | 8 | 4.5 | 5.6 | 7.8 | 7.6 |
| | ACA-29% | | | | | | | |
| | MB AE ® | | | | | | | |
| | 90-1.8 | | | | | | | |

Table 6 shows the results of water soluble polyoxyalkylene air controlling agents (6-7 to 6-32) compared to an insoluble polyoxyalkylene defoamer. Examples 6-1 through 6-6 pertain to the insoluble polyoxyalkylene reference and show controlled and predictable air contents over time. Examples 6-7 through 6-12 show that a soluble air controlling agent can provide similarly predictable air contents over time. Examples 6-13 through 6-17 demonstrate that air contents can be adjusted by changing the dosage of the air entraining agent. Examples 6-18 through 6-23, 6-24 through 6-28, and 6-29 through 6-32 demonstrate that as the solubility (HLB) increases, that similar and predictable air contents can be obtained by increasing the percentage of the air controlling agent in the polycarboxylate dispersant, adjusting the air entraining agent dosage, or both.

### EXAMPLE 7

Concrete mixes were prepared that varied the amount of one insoluble and one soluble ethoxylated acetylenic diol, SURFYNOL® 440 and SURFYNOL® 465, the amount of air entraining agent, MB AE® 90, and the amount of dispersant. The air entrainer amount is listed as fluid ounces per hundred weight of cement, and the dispersant was added as % per hundred weight of cement. The dispersant was a polymeric carboxylate backbone with polyether side chains. The amount of air controlling agent was based on the active amount of dispersant added. The dispersant and air controlling agent were added together with the water and the air entraining agent was added with the sand. The test results are listed below in Table 7.

TABLE 7

| | | | Slump (inches) | | | Air (%) | | |
|---|---|---|---|---|---|---|---|---|
| | | W/C | 5 | 10 | 15 | 5 | 10 | 15 |
| Mix | Admixture | ratio | min | min | min | min | min | min |
| 7-1 | Dispersant-0.2 | 0.407 | 4.25 | 4.25 | 2.5 | 3.7 | 3.6 | 3.4 |
| | SUR- | | | | | | | |
| | FYNOL ® | | | | | | | |
| | 440-6% | | | | | | | |
| | MB AE ® | | | | | | | |
| | 90-1 | | | | | | | |
| 7-2 | Dispersant-0.2 | 0.392 | 7 | 6.5 | 4.25 | 7.6 | 8.1 | 7.2 |
| | SUR- | | | | | | | |
| | FYNOL ® | | | | | | | |
| | 465-10.3% | | | | | | | |
| | MB AE ® | | | | | | | |
| | 90-1.0 | | | | | | | |
| 7-3 | Dispersant-0.08 | 0.501 | 7.25 | 6 | 4.75 | 3.4 | 3.0 | 2.9 |
| | SUR- | | | | | | | |
| | FYNOL ® | | | | | | | |
| | 440-20.3% | | | | | | | |
| | MB AE ® | | | | | | | |
| | 90-0.8 | | | | | | | |
| 7-4 | Dispersant-0.08 | 0.479 | 7.5 | 7.25 | 6 | 9.0 | 9.4 | 9.0 |
| | SUR- | | | | | | | |
| | FYNOL ® | | | | | | | |
| | 465-34.89% | | | | | | | |
| | MB AE ® | | | | | | | |
| | 90-0.8 | | | | | | | |

Table 7 shows that predictable air contents were obtained with the various levels of dispersant and soluble, ethoxylated acetylenic diol air controlling agent, which was similar to the insoluble reference of the same chemistry.

### EXAMPLE 8

Concrete mixtures were prepared at a ready mix plant to confirm the effectiveness of a water soluble air controlling agent in practice under field conditions, such as truck mixing. Mixes 8-1 and 8-3 represent a soluble air controlling agent (HLB=5), PLURONIC® L-31. Mix 8-2 represents an insoluble defoamer (HLB=3), PLURONIC® L-61. Mix 8-4 represents the non-silicone proprietary mixture as in Example 4-12, SURFYNOL® DF-75.

The air controlling agent and reference defoamers were tested in combination with a polycarboxylate dispersant and an air entraining agent, MB AE® 90. The reference dispersant was a polymeric carboxylate backbone with polyether side chains. The dispersant amount is listed as % per hundred weight of cement. The amount of air controlling agent was based on the active amount of dispersant added. The air entrainer amount is listed as fluid ounces per hundred weight of cement. The concrete mix proportions are listed in Table 8 below. For examples 8-1 and 8-2, the dispersant and air controlling agent or reference defoamer combination was added to a concrete mix having a 2-3.5″ slump. Examples 8-3 and 8-4 had the combination added immediately after batching all of the ingredients.

TABLE 8

| Mix | 8-1 | 8-2 | 8-3 | 8-4 |
|---|---|---|---|---|
| ACA level | 12.48 | 19.6 | 4.0 | 0.5 |
| Dispersant level | 0.08 | 0.08 | 0.2 | 0.2 |
| Air Entrainer dose | 0.5 | 1.0 | 0.6 | 0.6 |
| Cement (lb./yd³) | 607 | 600 | 615 | 582 |
| Sand (lb./yd³) | 1174 | 1167 | 1239 | 1180 |
| Stone (lb./yd³) | 1760 | 1742 | 1736 | 1637 |
| Water (lb./yd³) | 278 | 271 | 217 | 219 |
| W/C | 0.458 | 0.452 | 0.353 | 0.376 |
| S/A | 0.400 | 0.401 | 0.416 | 0.419 |

Slump (inches)

| | | | | |
|---|---|---|---|---|
| Initial | 2 | 3.5 | | |
| After dispersant added | 7.75 | 7.75 | 8.25 | 9 |
| 30 minutes | 5 | 4.75 | 9 | 8.25 |
| 60 minutes | 3.5 | 3.25 | 9 | |

Air (%)

| | | | | |
|---|---|---|---|---|
| Initial | 4.1 | 7.4 | | |
| After dispersant added | 5.4 | 6.5 | 7 | 11.8 |
| 30 minutes | 4.3 | 4.8 | 6.3 | 13.1 |
| 60 minutes | 3.6 | 4.3 | 6.4 | |

The results shown in Table 8 demonstrate that the water soluble air controlling agent is effective under field conditions, and that it provided predictable air contents that were maintained over a 60 minute time frame. A similar air content response was observed for the soluble air controlling agent and insoluble defoamer when used with a dispersant level of 0.08%. The non-silicone proprietary mixture reference was found to have high and unpredictable air contents over time.

Therefore, the present invention provides an admixture containing a polycarboxylate dispersant and a water soluble air controlling agent for controlling the amount of air in a predictable manner in cementitious compositions, and which is stable over time.

The invention also provides a cementitious composition comprising cement, water, a water soluble air controlling agent, and a polycarboxylate dispersant for controlling the amount of air in a predictable manner in the cementitious composition.

The present invention also provides a method of making a cementitious composition comprising mixing cement, water, a water soluble air controlling agent, and a polycarboxylate dispersant for controlling the amount of air in a predictable manner in cementitious compositions.

The present invention also provides a water soluble air controlling agent to be used in conjunction with a polycarboxylate dispersant that is as effective at controlling the air content in cementitious compositions.

It should be appreciated that the present invention is not limited to the specific embodiments described above, but includes variations, modifications and equivalent embodiments defined by the following claims.

What is claimed is:

1. An admixture for cementitious compositions comprising a water soluble air controlling agent and a dispersant for cementitious compositions, wherein the dispersant is at least one of
a) a dispersant of Formula (I): 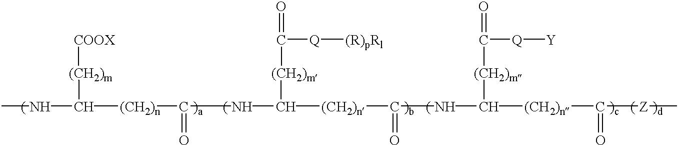
wherein in Formula (I)
X is at least one of hydrogen, an alkali earth metal ion, an alkaline earth metal ion, ammonium ion, and amine;
R is at least one of C₁ to C₆ alkyl(ene) ether and mixtures thereof and C₁ to C₆ alkyl(ene) imine and mixtures thereof;
Q is at least one of oxygen, NH, and sulfur;
p is a number from 1 to about 300 resulting in at least one of a linear side chain and branched side chain;
R₁ is at least one of hydrogen, C₁ to C₂₀ hydrocarbon, and functionalized hydrocarbon containing at least one of —OH, —COOH, an ester or amide derivative of —COOH, sulfonic acid, an ester or amide derivative of sulfonic acid, amine, and epoxy;
Y is at least one of hydrogen, an alkali earth metal ion, an alkaline earth metal ion, ammonium ion, amine, a hydrophobic hydrocarbon and polyalkylene oxide moiety that functions as a defoamer;
m, m′, m″, n, n′, and n″ are each independently 0 or an integer between 1 and about 20;
Z is a moiety containing at least one of i) at least one amine and one acid group, ii) two functional groups capable of incorporating into the backbone selected from the group consisting of dianhydrides, dialdehydes, and di-acid-chlorides, and iii) an imide residue; and
wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero.
b) a dispersant of Formula (II): 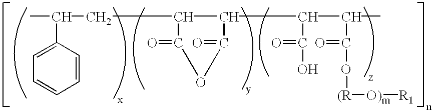
wherein in Formula (II):
R is a C₂₋₆ alkylene radical;
R₁ is a C₁₋₂₀ alkyl, C₆₋₉ cycloalkyl or phenyl group;
x, y, and z are number from 0.01 to 100;
m is a number from 1 to 100; and
n is a number from 10 to 100;
c) a dispersant of Formula (III): 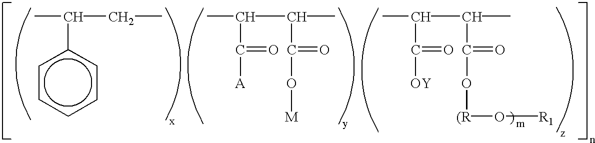
wherein in Formula (III):
M is hydrogen or the residue of a hydrophobic polyalkylene glycol or polysiloxane;
Y is hydrogen, an alkali or alkaline earth metal ion, ferrous ion, aluminum ion, (alkanol)ammonium ion, or (alkyl)ammonium ion;
R is a C₂₋₆ alkylene radical;
R₁ is a C₁₋₂₀ alkyl, C₆₋₉ cycloalkyl, or phenyl group;
x, y, and z are numbers from 1 to 100;
d) a dispersant comprising at least one polymer or a salt thereof having the form of a copolymer of
i) a maleic anhydride half-ester with a compound of the formula RO(AO)ₘH, wherein R is a C₁-C₂₀ alkyl group, A is a C₂₋₄ alkylene group, and m is an integer from 2-16; and
ii) a monomer having the formula CH₂═CHCH₂—(OA)ₙOR, wherein n is an integer from 1-90 and R is a C₁₋₂₀ alkyl group;
e) a reaction product formed by reacting a polycarboxylic acid with a nitrogeneous acrylic polymer;
f) a dispersant obtained by copolymerizing 5 to 98% be weight of an (alkoxy)polyalkylene glycol mono(meth)acrylic ester type monomer (a) represented by the following general formula (1): 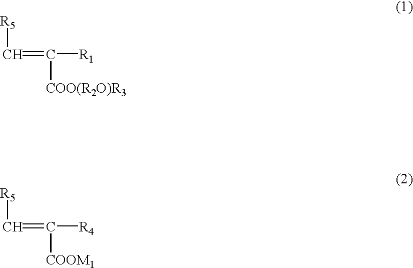
wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid type monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
g) a graft polymer that is a polycarboxylic acid or a salt thereof, having side chains derived from at least one species selected from the group consisting of oligoalkyleneglycols, polyalcohols, polyalkylene glycols, and derivatives thereof;
h) a styrene-maleic anhydride copolymer in free acid or salt form, wherein the copolymer consists of the following types and numbers of monomer units: 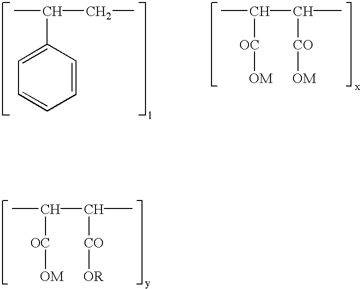
wherein:
M is selected from hydrogen, a cation and a residue of a hydrophobic polyalkylene glycol or polysiloxane;
R is the residue of a methylpoly(ethylene) glycol of weight average molecular weight 900-2000;
x=0.35-0.75; and
y=0.25-0.65;
i) a reaction product of component A, optionally component B, and component C; wherein each component A is independently a nonpolymeric, functional moiety that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof; wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof;
j) a dispersant of Formula (IV) 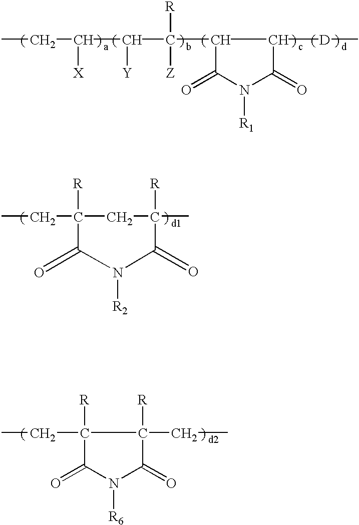
wherein in Formula (IV):
D=a component selected from the group consisting of the structure d1, the structure d2, and mixtures thereof;
X=H, CH₃, C₂ to C₆ Alkyl, Phenyl, Substituted Phenyl such as p-Methyl Phenyl, Sulfonated Phenyl;
Y=H, —COOM;
R=H, CH_{3;}
Z=H, —SO₃M, —PO₃M, —COOM, —OR_{3,}—COOR_{3,}—CH₂OR_{3,}—CONHR₃, —CONHC(CH₃)₂ CH₂SO₃M, —COO(CHR₄)ₙOH where n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene n in the random copolymer is from about 60% to 100% and the amount of oxypropylene in the random copolymer is from 0% to about 40%;
R₄=H, Methyl, C₂ to about C₆ Alkyl, about C₆ to about C₁₀ aryl;
M=H, Alkali Metal, Alkaline Earth Metal, Ammonium, Amine, Substituted Amine such as triethanol amine, Methyl, C₂ to about C₆ Alkyl;
a=0 to about 0.8;
b=about 0.2 to about 1.0;
c=0 to about 0.5;
d=0 to about 0.5; and
wherein a, b, c, and d represent the mole fraction of each unit and the sum of a, b, c, anddis 1.0;
k) a dispersant of Formula (V): 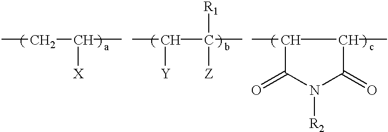
wherein in Formula (V):
the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, or Substituted Phenyl such as p-Methyl Phenyl, p-Ethyl Phenyl, Carboxylated Phenyl, Sulfonated Phenyl and the like;
Y=H, —COOM, —COOH, or W;
W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the derivatized polycarboxylate dispersant;
Z=H, —COOM, —OR_{3,}—COOR_{3,}—CH₂OR₃, or —CONHR_{3;}
R₁=H, or CH_{3;}
R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, Substituted Amine such as monoethanol amine, diethanol amine, triethanol amine, morpholine, imidazole and the like;
a=0.01-0.8;
b=0.2-0.99;
c=0-0.5; and
wherein a, b, c represent the mole fraction of each unit and the sum of a, b, and c, is 1;
l) a random copolymer corresponding to the following Formula (VI) in free acid or salt form having the following types and numbers of monomer units: 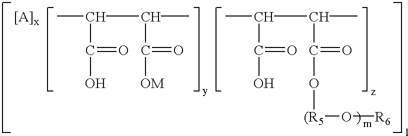
wherein A is selected from the moieties (i) and (ii) 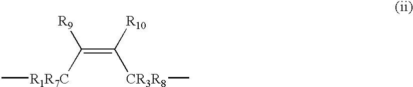
(i) —CR₁R₂—CR₃R₄—
wherein R₁ and R₃ are selected from substituted benzene, C₁₋₈ alkyl, C₂₋₈ alkenyl, C₂₋₈ alkylcarbonyl, C₁₋₈ alkoxy, carboxyl, and hydrogen, or R₁ and R₃ can together with R₂ and/or R₄ form a ring; and R₂ and R₄ are selected from the group consisting of hydrogen and C₁₋₄ alkyl;
R₇, R₈, R₉, and R₁₀ are individually selected from the group consisting of hydrogen, C₁₋₆ alkyl, or R₁ and R₃ together with R₇ and/or R₈, R₉, and R₁₀ form a continuous C₂₋₈ hydrocarbon chain joining the carbon atoms to which they are attached, the hydrocarbon chain optionally having at least one anionic group, preferably sulphonic;
M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
R₅ is a C₂₋₈ alkylene radical;
R₆ is selected from the group consisting of C₁₋₂₀ alkyl, C₆₋₉ cycloalkyl and phenyl;
n, x, and z are numbers from 1 to 100;
y is 0to 100;
m is 2 to 1000;
the ratio of x to (y+z) is from 1:10 to 10:1 and the ratio of y:z is from 5:1 to 1:100;
m) a copolymer based on oxyalkyleneglycol-alkenyl ethers and unsaturated dicarboxylic acid derivatives, comprising:
i) 10 to 90 mol % of component of the formula Ia and or Ib: 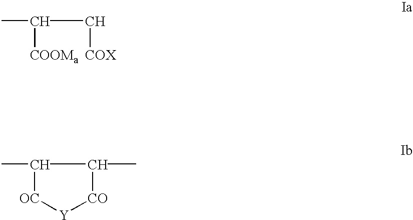
wherein M is a hydrogen atom, a mono- or divalent metal cation, an amonium ion or an organic amine residue, a is 1, or when M is a divalent metal cation is ½, X is —OMₐ or —O—(CₘH₂ₘO)ₙ—R₁, in which R₁ is a hydrogen atom, an aliphatic hydrocarbon radical containing from 1 to 20 carbon atoms, a cycloaliphatic hydrocarbon radical containing 5 to 8 carbon atoms or an optionally substituted aryl radical containing 6 to 14 carbon atoms, m is 2 to 4, n is 0 to 100,—NHR₂ and/or —N(R₂)₂, in which R₂═R₁ or —CO—NH₂, and Y is an oxygen atom or —NR₂;
ii) 1 to 89 mol % of components of the general formula: 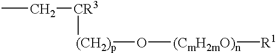
wherein R₃ is a hydrogen atom or an aliphatic hydrocarbon radical containing from 1 to 5 carbon atoms, p is 0 to 3, and R₁, m, and n have the above-given meanings, and
iii) 0.1 to 10 mol % of components of the general formulae: 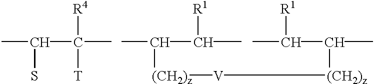
wherein S is a hydrogen atom or —COOMₐ or —COOR₅, T is —COOR₅, —W—R_{7,}—CO—[—NH—(CH2)3)-]ₛ_{—W—R}_{7,}—CO—O—(CH₂)_{z}—W—R₇, a radical of the general formula: 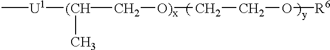
or —(CH₂)_{z}—V—(CH₂)_{z}—CH═CH—R₁, or when S is —COOR₅ or —COOMₐ, U₁ is —CO—NHM—, —O— or —CH₂O, U₂ is —NH—CO—, —O— or —OCH₂, V is —O—CO—C₆H₄—CO—O— or —W—, and W is 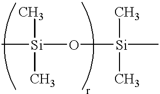
R₄ is a hydrogen atom or a methyl radical, R₅ is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or 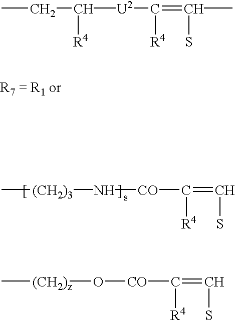
r is 2 to 100, s is 1 or 2, x is 1 to 150, y is o to 15 and z is 0 to 4.

2. The admixture of claim 1, wherein the water soluble air controlling agent is at least one of an alkoxylated R, wherein R is at least one of a hydrocarbon, sorbitan, polypropylene oxide, fatty acid, fatty alcohol, or C₈-C₂₂ alkyl amine.

3. The admixture of claim 1 further comprising an air entrainer.

4. The admixture of claim 1 further comprising at least one of a set accelerator, a set retarder, an air entraining agent, an air detraining agent, a foaming agent, a corrosion inhibitor, another cement dispersing agent, pozzolan, and a pigment.

5. The admixture of claim 1, wherein the water soluble air controlling agent is present in an amount from about 0.25% to about 40% based on the weight of the dispersant for cementitious compositions.

6. The admixture of claim 1, wherein the water soluble air controlling agent is present in an amount from about 1% to about 20% based on the weight of the dispersant for cementitious compositions.

7. A cementitious composition comprising cement, water, a water soluble air controlling agent and a dispersant for cementitious compositions, wherein the dispersant is at least one of
a) a dispersant of Formula (I): 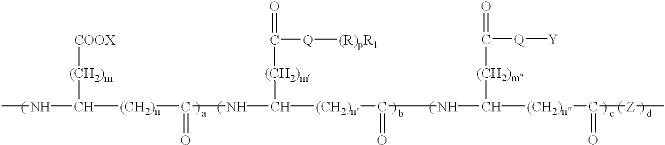
wherein in Formula (I)
X is at least one of hydrogen, an alkali earth metal ion, an alkaline earth metal ion, ammonium ion, and amine;
R is at least one of C₁ to C₆ alkyl(ene) ether and mixtures thereof and C₁ to C₆ alkyl(ene) imine and mixtures thereof;
Q is at least one of oxygen, NH, and sulfur;
p is a number from 1 to about 300 resulting in at least one of a linear side chain and branched side chain;
R₁ is at least one of hydrogen, C₁ to C₂₀ hydrocarbon, and functionalized hydrocarbon containing at least one of —OH, —COOH, an ester or amide derivative of —COOH, sulfonic acid, an ester or amide derivative of sulfonic acid, amine, and epoxy;
Y is at least one of hydrogen, an alkali earth metal ion, an alkaline earth metal ion, ammonium ion, amine, a hydrophobic hydrocarbon and polyalkylene oxide moiety that functions as a defoamer;
m, m′, m″, n, n′, and n″ are each independently 0 or an integer between 1 and about 20;
Z is a moiety containing at least one of i) at least one amine and one acid group, ii) two functional groups capable of incorporating into the backbone selected from the group consisting of dianhydrides, dialdehydes, and di-acid-chlorides, and iii) an imide residue; and
wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero.
b) a dispersant of Formula (II) 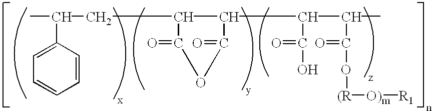
wherein in Formula (II):
R is a C₂₋₆ alkylene radical;
R₁ is a C₁₋₂₀ alkyl, C₆₋₉ cycloalkyl or phenyl group;
x, y, and z are number from 0.01 to 100;
m is a number from 1 to 100; and
n is a number from 10 to 100;
c) a dispersant of Formula (III): 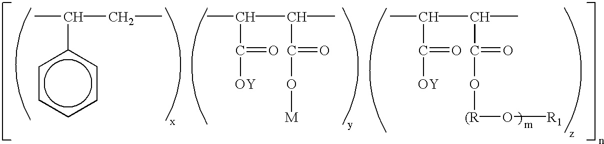
wherein in Formula (III):
M is hydrogen or the residue of a hydrophobic polyalkylene glycol or polysiloxane;
Y is hydrogen, an alkali or alkaline earth metal ion, ferrous ion, aluminum ion, (alkanol)ammonium ion, or (alkyl)ammonium ion;
R is a C₂₋₆ alkylene radical;
R₁ is a C₁₋₂₀ alkyl, C₆₋₉ cycloalkyl, or phenyl group;
x, y, and z are numbers from 1 to 100;
d) a dispersant comprising at least one polymer or a salt thereof having the form of a copolymer of
i) a maleic anhydride half-ester with a compound of the formula RO(AO)ₘH, wherein R is a C₁-C₂₀ alkyl group, A is a C₂₋₄ alkylene group, and m is an integer from 2-16; and
ii) a monomer having the formula CH₂═CHCH₂—(OA)ₙOR, wherein n is an integer from 1-90 and R is a C₁₋₂₀ alkyl group;
e) a reaction product formed by reacting a polycarboxylic acid with a nitrogeneous acrylic polymer;
f) a dispersant obtained by copolymerizing 5 to 98% be weight of an (alkoxy)polyalkylene glycol mono(meth)acrylic ester type monomer (a) represented by the following general formula (1): 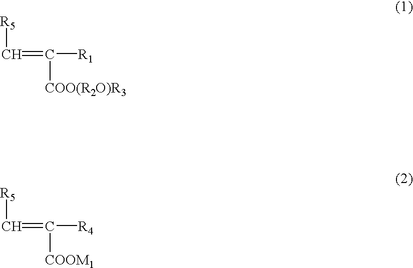
wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid type monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
g) a graft polymer that is a polycarboxylic acid or a salt thereof, having side chains derived from at least one species selected from the group consisting of oligoalkyleneglycols, polyalcohols, polyalkylene glycols, and derivatives thereof;
h) a styrene-maleic anhydride copolymer in free acid or salt form, wherein the copolymer consists of the following types and numbers of monomer units: 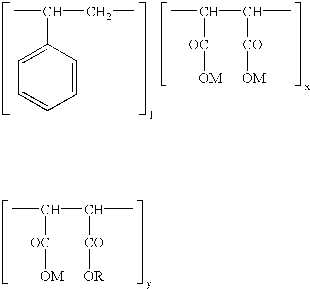
wherein:
M is selected from hydrogen, a cation and a residue of a hydrophobic polyalkylene glycol or polysiloxane;
R is the residue of a methylpoly(ethylene) glycol of weight average molecular weight 900-2000;
x=0.35-0.75; and
y=0.25-0.65;
i) a reaction product of component A, optionally component B, and component C; wherein each component A is independently a nonpolymeric, functional moiety that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof; wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof;
j) a dispersant of Formula (IV): 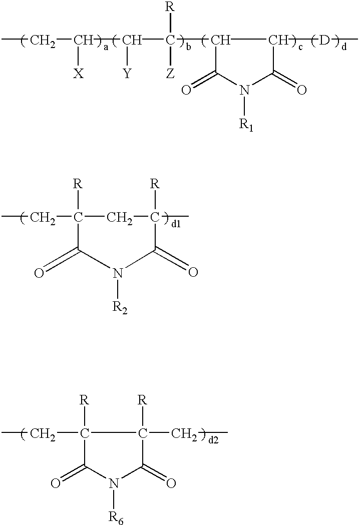
wherein in Formula (IV):
D=a component selected from the group consisting of the structure d1, the structure d2, and mixtures thereof;
X=H, CH₃, C₂ to C₆ Alkyl, Phenyl, Substituted Phenyl such as p-Methyl Phenyl, Sulfonated Phenyl;
Y=H,—COOM;
R=H, CH₃;
Z=H, —SO₃M, —PO₃M, —COOM, —OR_{3,}—COOR_{3,}—CH₂OR_{3,}—CONHR₃, —CONHC(CH₃)₂ CH₂SO₃M, —COO(CHR₄)ₙOH where n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, about C₆ to about C₁₀ aryl;
M=H, Alkali Metal, Alkaline Earth Metal, Ammonium, Amine, Substituted Amine such as triethanol amine, Methyl, C₂ to about C₆ Alkyl;
a=0 to about 0.8;
b=about 0.2 to about 1.0;
c=0 to about 0.5;
d=0 to about 0.5; and
wherein a, b, c, and d represent the mole fraction of each unit and the sum of a, b, c, and d is 1.0;
k) a dispersant of Formula (V): 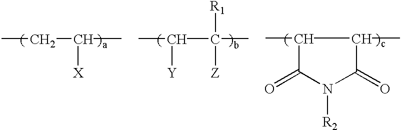
wherein in Formula (V):
the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, or Substituted Phenyl such as p-Methyl Phenyl, p-Ethyl Phenyl, Carboxylated Phenyl, Sulfonated Phenyl and the like;
Y=H, —COOM, —COOH, or W;
W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the derivatized polycarboxylate dispersant;
Z=H, —COOM, —OR_{3,}—COOR_{3,}—CH₂OR₃, or —CONHR₃;
R₁=H, or CH₃;
R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, Substituted Amine such as monoethanol amine, diethanol amine, triethanol amine, morpholine, imidazole and the like;
a=0.01-0.8;
b=0.2-0.99;
c=0-0.5; and
wherein a, b, c represent the mole fraction of each unit and the sum of a, b, and c, is 1;
l) a random copolymer corresponding to the following Formula (VI) in free acid or salt form having the following types and numbers of monomer units: 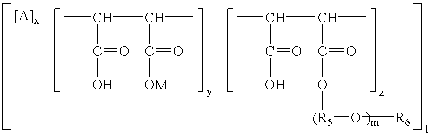
wherein A is selected from the moieties (i) and (ii)
(i) —CRlR₂-CR₃R₄— 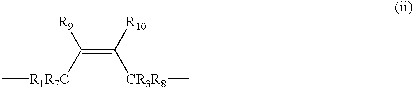
wherein R₁ and R₃ are selected from substituted benzene, C₁₋₈ alkyl, C₂₋₈ alkenyl, C₂₋₈ alkylcarbonyl, C₁₋₈ alkoxy, carboxyl, and hydrogen, or R₁ and R₃ can together with R₂ and/or R₄ form a ring; and R₂ and R₄ are selected from the group consisting of hydrogen and C₁₋₄ alkyl;
R₇, R₈, R₉, and R₁₀ are individually selected from the group consisting of hydrogen, C₁₋₆ alkyl, or R₁ and R₃ together with R₇ and/or R₈, R₉, and R₁₀ form a continuous C₂₋₈ hydrocarbon chain joining the carbon atoms to which they are attached, the hydrocarbon chain optionally having at least one anionic group, preferably sulphonic;
M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
R₅ is a C₂₋₈ alkylene radical;
R₆ is selected from the group consisting of C₁₋₂₀ alkyl, C₆₋₉ cycloalkyl and phenyl;
n, x, and z are numbers from 1 to 100;
y is 0 to 100;
m is 2 to 1000;
the ratio of x to (y+z) is from 1:10 to 10:1 and the ratio of y:z is from 5:1 to 1:100;
m) a copolymer based on oxyalkyleneglycol-alkenyl ethers and unsaturated dicarboxylic acid derivatives, comprising:
i) 10 to 90 mol % of component of the formula Ia and or Ib: 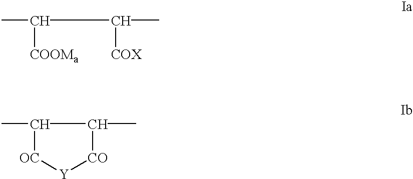
wherein M is a hydrogen atom, a mono- or divalent metal cation, an amonium ion or an organic amine residue, a is 1, or when M is a divalent metal cation is ½, X is —OMₐ or —O—(CₘH₂ₘO)ₙ—R₁, in which R₁ is a hydrogen atom, an aliphatic hydrocarbon radical containing from 1 to 20 carbon atoms, a cycloaliphatic hydrocarbon radical containing 5 to 8 carbon atoms or an optionally substituted aryl radical containing 6 to 14 carbon atoms, m is 2 to 4, n is 0 to 100,—NHR₂ and/or —N(R₂)₂, in which R₂═R₁ or —CO—NH₂, and Y is an oxygen atom or —NR₂;
ii) 1 to 89 mol % of components of the general formula: 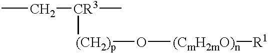
wherein R₃ is a hydrogen atom or an aliphatic hydrocarbon radical containing from 1 to 5 carbon atoms, p is 0 to 3, and R₁, m, and n have the above-given meanings, and
iii) 0.1 to 10 mol % of components of the general formulae: 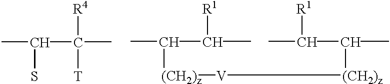
wherein S is a hydrogen atom or —COOMₐ or —COOR₅, T is —COOR₅, —W—R_{7,}—CO—[—NH—(CH2)3)-]ₛ—W—R_{7,}—CO—O—(CH₂)_{z}—W—R₇, a radical of the general formula: 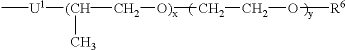
or —(CH₂)_{z}—V—(CH₂)_{z}—CH═CH—R₁, or when S is —COOR₅ or —COOMₐ, U₁ is —CO—NHM—, —O— or —CH₂O, U₂ is —NH—CO—, —O— or —OCH₂, V is —O—CO—C₆H₄—CO—O— or —W—, and W is 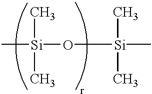
R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or 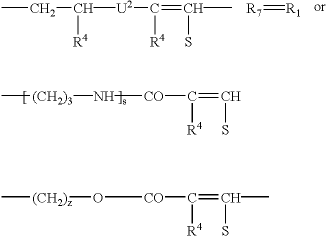
r is 2to 100, s is 1 or 2, x is 1 to 150, y is o to 15and z is 0to 4.

8. The cementitious composition of claim 7, wherein the water soluble air controlling agent is at least one of an alkoxylated R, wherein R is at least one of a hydrocarbon, sorbitan, polypropylene oxide, fatty acid, fatty alcohol, or C₈-C₂₂ alkyl amine.

9. The cementitious composition of claim 7, wherein the cement is selected from the group consisting of portland cement, masonry cement, alumina cement, refractory cement, magnesia cement, calcium sulfoaluminate cement, oil well cement, and mixtures thereof.

10. The cementitious composition of claim 7 further comprising a cement admixture or additive that is at least one of a set accelerator, a set retarder, an air entraining agent, an air detraining agent, a foaming agent, a corrosion inhibitor, another cement dispersing agent, a pigment, a pozzolan, clay, and aggregate.

11. The cementitious composition of claim 10, wherein the aggregate is at least one of silica, quartz, crushed round marble, glass spheres, granite, limestone, calcite, feldspar, alluvial sands, and sand.

12. The cementitious composition of claim 10, wherein the pozzolan is at least one of natural pozzolan, fly ash, silica fume, calcined clay, and blast furnace slag.

13. The cementitious composition of claim 7, wherein the water soluble air controlling agent is present in an amount from about 0.25% to about 40% based on the weight of the dispersant for cementitious compositions.

14. The cementitious composition of claim 7, wherein the water soluble air controlling agent is present in an amount from about 1% to about 20% based on the weight of the dispersant for cementitious compositions.

15. A method of making a cementitious composition comprising mixing cement, water, a water soluble air controlling agent and a dispersant for cementitious compositions, wherein the dispersant is at least one of
a) a dispersant of Formula (I): 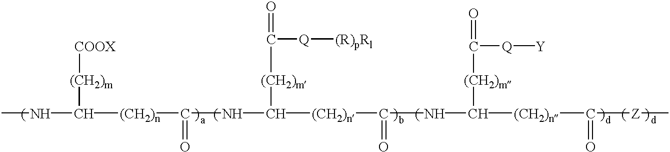
wherein in Formula (I)
X is at least one of hydrogen, an alkali earth metal ion, an alkaline earth metal ion, ammonium ion, and amine;
R is at least one of C₁ to C₆ alkyl(ene) ether and mixtures thereof and C₁ to C₆ alkyl(ene) imine and mixtures thereof;
Q is at least one of oxygen, NH, and sulfur;
p is a number from 1 to about 300 resulting in at least one of a linear side chain and branched side chain;
R₁ is at least one of hydrogen, C₁ to C₂₀ hydrocarbon, and functionalized hydrocarbon containing at least one of —OH, —COOH, an ester or amide derivative of —COOH, sulfonic acid, an ester or amide derivative of sulfonic acid, amine, and epoxy;
Y is at least one of hydrogen, an alkali earth metal ion, an alkaline earth metal ion, ammonium ion, amine, a hydrophobic hydrocarbon and polyalkylene oxide moiety that functions as a defoamer;
m, m′, m″, n, n′, and n″ are each independently 0 or an integer between 1 and about 20;
Z is a moiety containing at least one of i) at least one amine and one acid group, ii) two functional groups capable of incorporating into the backbone selected from the group consisting of dianhydrides, dialdehydes, and di-acid-chlorides, and iii) an imide residue; and
wherein a, b, c, and d reflect the mole fraction of each unit wherein the sum of a, b, c, and d equal one, wherein a, b, c, and d are each a value greater than or equal to zero and less than one, and at least two of a, b, c, and d are greater than zero.
b) a dispersant of Formula (II): 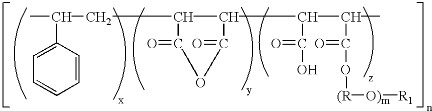
wherein in Formula (II):
R is a C₂₋₆ alkylene radical;
R₁ is a C₁₋₂₀ alkyl, C₆₋₉ cycloalkyl or phenyl group;
x, y, and z are number from 0.01 to 100;
m is a number from 1 to 100; and
n is a number from 10 to 100;
c) a dispersant of Formula (III): 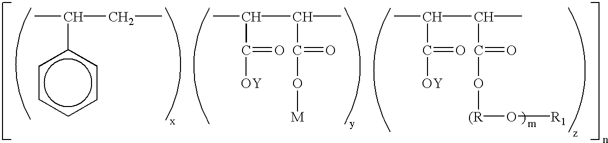
wherein in Formula (III):
M is hydrogen or the residue of a hydrophobic polyalkylene glycol or polysiloxane;
Y is hydrogen, an alkali or alkaline earth metal ion, ferrous ion, aluminum ion, (alkanol)ammonium ion, or (alkyl)ammonium ion;
R is a C₂₋₆ alkylene radical;
R₁ is a C₁₋₂₀ alkyl, C₆₋₉ cycloalkyl, or phenyl group;
x, y, and z are numbers from 1 to 100;
d) a dispersant comprising at least one polymer or a salt thereof having the form of a copolymer of
i) a maleic anhydride half-ester with a compound of the formula RO(AO)ₘH, wherein R is a C₁-C₂₀ alkyl group, A is a C₂₋₄ alkylene group, and m is an integer from 2-16; and
ii) a monomer having the formula CH₂═CHCH₂—(OA)ₙOR, wherein n is an integer from 1-90 and R is a C₁₋₂₀ alkyl group;
e) a reaction product formed by reacting a polycarboxylic acid with a nitrogeneous acrylic polymer;
f) a dispersant obtained by copolymerizing 5 to 98% be weight of an (alkoxy)polyalkylene glycol mono(meth)acrylic ester type monomer (a) represented by the following general formula (1): 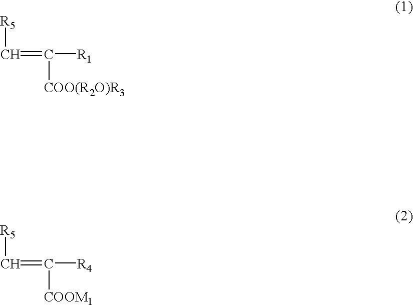
wherein R₁ stands for hydrogen atom or a methyl group, R₂O for one species or a mixture of two or more species of oxyalkylene group of 2 to 4 carbon atoms, providing two or more species of the mixture may be added either in the form of a block or in a random form, R₃ for a hydrogen atom or an alkyl group of 1 to 5 carbon atoms, and m is a value indicating the average addition mol number of oxyalkylene groups that is an integer in the range of 1 to 100, 95 to 2% by weight of a (meth)acrylic acid type monomer (b) represented by the above general formula (2), wherein R₄ and R₅ are each independently a hydrogen atom or a methyl group, and M₁ for a hydrogen atom, a monovalent metal atom, a divalent metal atom, an ammonium group, or an organic amine group, and 0 to 50% by weight of other monomer (c) copolymerizable with these monomers, provided that the total amount of (a), (b), and (c) is 100% by weight;
g) a graft polymer that is a polycarboxylic acid or a salt thereof, having side chains derived from at least one species selected from the group consisting of oligoalkyleneglycols, polyalcohols, polyalkylene glycols, and derivatives thereof;
h) a styrene-maleic anhydride copolymer in free acid or salt form, wherein the copolymer consists of the following types and numbers of monomer units: 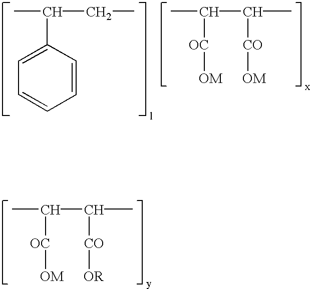
wherein:
M is selected from hydrogen, a cation and a residue of a hydrophobic polyalkylene glycol or polysiloxane;
R is the residue of a methylpoly(ethylene) glycol of weight average molecular weight 900-2000;
x=0.35-0.75; and
y=0.25-0.65;
i) a reaction product of component A, optionally component B, and component C; wherein each component A is independently a nonpolymeric, functional moiety that adsorbs onto a cementitious particle, and contains at least one residue derived from a first component selected from the group consisting of phosphates, phosphonates, phosphinates, hypophosphites, sulfates, sulfonates, sulfinates, alkyl trialkoxy silanes, alkyl triacyloxy silanes, alkyl triaryloxy silanes, borates, boronates, boroxines, phosphoramides, amines, amides, quaternary ammonium groups, carboxylic acids, carboxylic acid esters, alcohols, carbohydrates, phosphate esters of sugars, borate esters of sugars, sulfate esters of sugars, salts of any of the preceding moieties, and mixtures thereof; wherein component B is an optional moiety, where if present, each component B is independently a nonpolymeric moiety that is disposed between the component A moiety and the component C moiety, and is derived from a second component selected from the group consisting of linear saturated hydrocarbons, linear unsaturated hydrocarbons, saturated branched hydrocarbons, unsaturated branched hydrocarbons, alicyclic hydrocarbons, heterocyclic hydrocarbons, aryl, phosphoester, nitrogen containing compounds, and mixtures thereof; and wherein component C is at least one moiety that is a linear or branched water soluble, nonionic polymer substantially non-adsorbing to cement particles, and is selected from the group consisting of poly(oxyalkylene glycol), poly(oxyalkylene amine), poly(oxyalkylene diamine), monoalkoxy poly(oxyalkylene amine), monoaryloxy poly(oxyalkylene amine), monoalkoxy poly(oxyalkylene glycol), monoaryloxy poly(oxyalkylene glycol), poly(vinyl pyrrolidones), poly(methyl vinyl ethers), poly(ethylene imines), poly(acrylamides), polyoxazoles, and mixtures thereof;
j) a dispersant of Formula (IV): 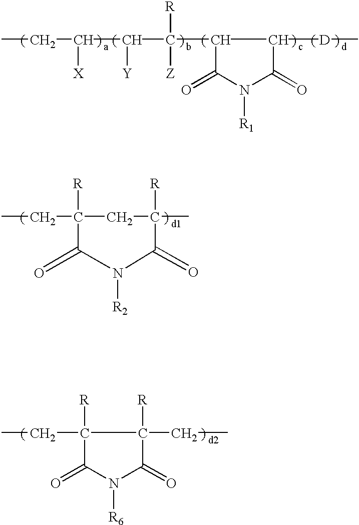
wherein in Formula (IV):
D=a component selected from the group consisting of the structure d1, the structure d2, and mixtures thereof;
X=H, CH₃, C₂ to C₆ Alkyl, Phenyl, Substituted Phenyl such as p-Methyl Phenyl, Sulfonated Phenyl;
Y=H, —COOM;
R=H, CH₃;
Z=H, —SO₃M, —PO₃M, —COOM, —OR_{3,}—COOR_{3,}—CH₂OR_{3,}—CONHR₃, —CONHC(CH₃)₂ CH₂SO₃M, —COO(CHR₄)ₙOH where n=2 to 6;
R₁, R₂, R₃, R₅ are each independently —(CHRCH₂O)ₘR₄ random copolymer of oxyethylene units and oxypropylene units where m=10 to 500 and wherein the amount of oxyethylene in the random copolymer is from about 60% to 100% and the amount of oxypropylene in the random copolymer is from 0% to about 40%;
R₄=H, Methyl, C₂ to about C₆ Alkyl, about C₆ to about C₁₀ aryl;
M=H, Alkali Metal, Alkaline Earth Metal, Ammonium, Amine, Substituted Amine such as triethanol amine, Methyl, C₂ to about C₆ Alkyl;
a=0 to about 0.8;
b=about 0.2 to about 1.0;
c=0 to about 0.5;
d=0 to about 0.5; and
wherein a, b, c, and d represent the mole fraction of each unit and the sum of a, b, c, and d is 1.0;
k) a dispersant of Formula (V): 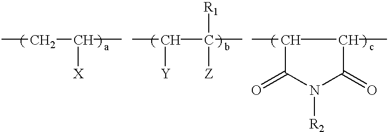
wherein in Formula (V):
the “b” structure is one of a substituted carboxylic acid monomer, a substituted ethylenically unsaturated monomer, and maleic anhydride wherein an acid anhydride group (—CO—O—CO—) is formed in place of the groups Y and Z between the carbon atoms to which the groups Y and Z are bonded respectively, and the “b” structure must include at least one moiety with a pendant ester linkage and at least one moiety with a pendant amide linkage;
X=H, CH₃, C₂ to C₆ Alkyl, Phenyl, or Substituted Phenyl such as p-Methyl Phenyl, p-Ethyl Phenyl, Carboxylated Phenyl, Sulfonated Phenyl and the like;
Y=H, —COOM, —COOH, or W;
W=a hydrophobic defoamer represented by the formula R₅O—(CH₂CH₂O)ₛ—(CH₂C(CH₃)HO)ₜ—(CH₂CH₂O)ᵤ where s, t, and u are integers from 0 to 200 with the proviso that t>(s+u) and wherein the total amount of hydrophobic defoamer is present in an amount less than about 10% by weight of the derivatized polycarboxylate dispersant;
Z=H, —COOM, —OR_{3,}—COOR_{3,}—CH₂OR₃, or —CONHR₃;
R₁=H, or CH₃;
R₂, R₃, are each independently a random copolymer of oxyethylene units and oxypropylene units of the general formula —(CH(R₁)CH₂O)ₘR₄ where m=10 to 500 and wherein the amount of oxyethylene in the random copolymer is from about 60% to 100% and the amount of oxypropylene in the random copolymer is from 0% to about 40%;
R₄=H, Methyl, or C₂ to C₈ Alkyl;
R₅=C₁ to C₁₈ alkyl or C₆ to C₁₈ alkyl aryl;
M=Alkali Metal, Alkaline Earth Metal, Ammonia, Amine, Substituted Amine such as monoethanol amine, diethanol amine, triethanol amine, morpholine, imidazole and the like;
a=0.01-0.8;
b=0.2-0.99;
C=0-0.5; and
wherein a, b, c represent the mole fraction of each unit and the sum of a, b, and c, is 1;
l) a random copolymer corresponding to the following Formula (VI) in free acid or salt form having the following types and numbers of monomer units: 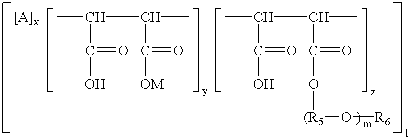
wherein A is selected from the moieties (i) and (ii) 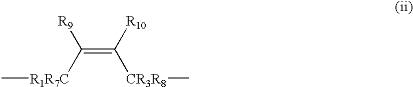
(i)-CRlR₂-CR₃R₄
wherein R₁ and R₃ are selected from substituted benzene, C₁₋₈ alkyl, C₂₋₈ alkenyl, C₂₋₈ alkylcarbonyl, C₁₋₈ alkoxy, carboxyl, and hydrogen, or R₁ and R₃ can together with R₂ and/or R₄ form a ring; and R₂ and R₄ are selected from the group consisting of hydrogen and C₁₋₄ alkyl;
R₇, R₈, R₉, and R₁₀ are individually selected from the group consisting of hydrogen, C₁₋₆ alkyl, or R₁ and R₃ together with R₇ and/or R₈, R₉, and R₁₀ form a continuous C₂₋₈ hydrocarbon chain joining the carbon atoms to which they are attached, the hydrocarbon chain optionally having at least one anionic group, preferably sulphonic;
M is selected from the group consisting of hydrogen, and the residue of a hydrophobic polyalkylene glycol or a polysiloxane, with the proviso that when A is (ii) and M is the residue of a hydrophobic polyalkylene glycol, M must be different from the group —(R₅O)ₘR₆;
R₅ is a C₂₋₈ alkylene radical;
R₆ is selected from the group consisting of C₁₋₂₀ alkyl, C₆₋₉ cycloalkyl and phenyl;
n, x, and z are numbers from 1 to 100;
y is 0 to 100;
m is 2 to 1000;
the ratio of x to (y+z) is from 1:10 to 10:1 and the ratio of y:z is from 5:1 to 1:100;
m) a copolymer based on oxyalkyleneglycol-alkenyl ethers and unsaturated dicarboxylic acid derivatives, comprising:
i) 10 to 90 mol % of component of the formula Ia and or Ib: 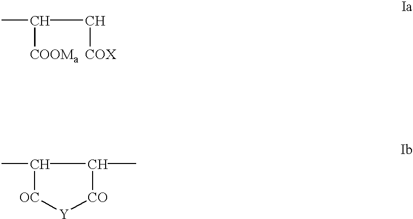
wherein M is a hydrogen atom, a mono- or divalent metal cation, an amonium ion or an organic amine residue, a is 1, or when M is a divalent metal cation is ½, X is —OMₐ or —O—(CₘH₂ₘO)ₙ—R₁, in which R₁ is a hydrogen atom, an aliphatic hydrocarbon radical containing from 1 to 20 carbon atoms, a cycloaliphatic hydrocarbon radical containing 5 to 8 carbon atoms or an optionally substituted aryl radical containing 6 to 14 carbon atoms, m is 2 to 4, n is 0 to 100,—NHR₂ and/or —N(R₂)₂, in which R₂═R₁ or —CO—NH₂, and Y is an oxygen atom or —NR₂;
ii) 1 to 89 mol % of components of the general formula: 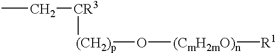
wherein R₃ is a hydrogen atom or an aliphatic hydrocarbon radical containing from 1 to 5 carbon atoms, p is 0 to 3, and R₁, m, and n have the above-given meanings, and
iii) 0.1 to 10 mol % of components of the general formulae: 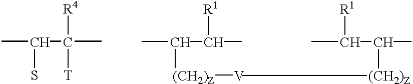
wherein S is a hydrogen atom or —COOMₐ or —COOR₅, T is —COOR₅, —W—R_{7,}—CO—[—NH—(CH2)3)-]ₛ—W—R_{7,}—CO—O—(CH₂)_{z}—W—R₇, a radical of the general formula: 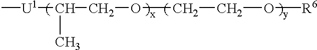
or —(CH₂)_{z}—V—(CH₂)_{z}—CH═CH—R₁, or when S is —COOR₅ or —COOMₐ, U₁ is —CO—NHM—, —O— or —CH₂O, U₂ is —NH—CO—, —O— or —OCH₂, V is —O—CO—C₆H₄—CO—O— or —W—, and W is 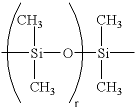
R4 is a hydrogen atom or a methyl radical, R5 is an aliphatic hydrocarbon radical containing 3 to 20 carbon atoms, a cycloaliphatic hydrocarbon radical containing 5 to 8 carbon atoms or an aryl radical containing 6 to 14 carbon atoms, R₆═R₁ or 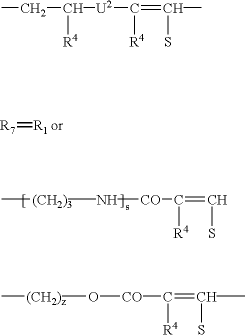
r is 2 to 100, s is 1 or 2, x is 1 to 150, y is o to 15 and z is 0 to 4.

16. The method of claim 15, wherein the water soluble air controlling agent is at least one of an alkoxylated R, wherein R is at least one of a hydrocarbon, sorbitan, polypropylene oxide, fatty acid, fatty alcohol, or C₈-C₁₂ alkyl amine.

17. The method of claim 15, wherein the cement is selected from the group consisting of portland cement, masonry cement, alumina cement, refractory cement, magnesia cement, calcium sulfoaluminate cement, oil well cement, and mixtures thereof.

18. The method of claim 15 further comprising mixing a cement admixture or additive into the cementitious composition, wherein the cement admixture or additive that is at least one of a set accelerator, a set retarder, an air entraining agent, an air detraining agent, a foaming agent, a corrosion inhibitor, another cement dispersing agent, a pigment, a pozzolan, clay, and aggregate.

19. The method of claim 18, wherein the aggregate is at least one of silica, quartz, crushed round marble, glass spheres, granite, limestone, calcite, feldspar, alluvial sands, and sand.

20. The method of claim 18, wherein the pozzolan is at least one of natural pozzolan, fly ash, silica fume, calcined clay, and blast furnace slag.

21. The method of claim 15, wherein the water soluble air controlling agent is present in an amount from about 0.25% to about 40% based on the weight of the dispersant for cementitious compositions.

22. The method of claim 15, wherein the water soluble air controlling agent is present in an amount from about 1% to about 20% based on the weight of the dispersant for cementitious compositions.

23. The method of claim 15, wherein the water soluble air controlling agent and the dispersant for cementitious compositions are added as one solution.

24. The method of claim 15, wherein the water soluble agent is added to the cementitious composition by one of i) separately, ii) in combination with the dispersant for cementitious compositions, and iii) in combination with an admixture.
